(19) United States
(12) Patent Application Publication
(10) Pub. No.: US 2024/0405932 A1
(43) Pub. Date: Dec. 5, 2024

(54) GENERATING ADAPTIVE BEAM WEIGHTS FOR COMMUNICATIONS WITH MULTIPLE TRANSMISSION RECEPTION POINTS

(71) Applicant: QUALCOMM Incorporated, San Diego, CA (US)

(72) Inventors: Vasanthan RAGHAVAN, West Windsor Township, NJ (US); Junyi LI, Fairless Hills, PA (US)

(21) Appl. No.: 18/327,836

(22) Filed: Jun. 1, 2023

(51) Int. Cl. H04L 5/00; H04B 7/0456

(52) U.S. Cl. CPC H04L 5/0035; H04B 7/0456; H04L 5/0005; H04L 5/0051

(57) ABSTRACT

Methods, systems, and devices for wireless communications are described. The described techniques provide for a user equipment (UE) to adaptively generate beam weights for use in communications with multiple transmission reception points (TRPs) at a single antenna panel of the UE. For example, the UE may perform reference signal measurements using coordinated reference signals from the multiple TRPs. The UE may use the reference signal measurements to generate and select adaptive beam weights. The UE may generate beams using the selected beam weights to receive and/or transmit signaling to or from the multiple TRPs at a single antenna panel of the UE. In some cases, the TRPs may indicate coordination information, such as timing alignment errors (TAEs) and carrier frequency offsets (CFOs), such that the UE may receive the reference signals and co-phase energy from the multiple TRPs at an antenna panel using a same set of time-frequency resources.

### FIELD OF TECHNOLOGY

The following relates to wireless communications, including generating adaptive beam weights for communications with multiple transmission reception points (TRPs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support generating adaptive beam weights for communications with multiple transmission reception points (TRPs). For example, the described techniques provide for a user equipment (UE) to adaptively generate beam weights for use in communications with multiple TRPs at a single antenna panel of the UE. In some cases, the UE may perform reference signal measurements using coordinated reference signals from the multiple TRPs. The UE may use the reference signal measurements to generate and select adaptive beam weights. The UE may generate beams using the selected beam weights to receive and/or transmit signaling to/from the multiple TRPs at a single antenna panel of the UE. In some cases, the TRPs may indicate coordination information, such as timing alignment errors (TAEs) and carrier frequency offsets (CFOs), such that the UE may receive the reference signals and co-phase energy from the multiple TRPs at an antenna panel using a same set of time-frequency resources.

A method for wireless communications at a UE is described. The method may include obtaining a set of multiple reference signal measurements corresponding to a plurality of TRPs, the set of multiple reference signal measurements associated with adaptive beam weight generation, selecting, in accordance with the set of multiple reference signal measurements, one or more first beam weights associated with a first link between one or more antenna panels at the UE and a first TRP of the set of multiple TRPs and one or more second beam weights associated with a second link between the one or more antenna panels at the UE and a second TRP of the set of multiple TRPs. and communicating, via the one or more antenna panels of the UE, with the first TRP using the one or more first beam weights and with the second TRP using the one or more second beam weights.

An apparatus for wireless communications at a UE is described. The apparatus may include at least one processor, at least one memory coupled with the at least one processor, and instructions stored in the at least one memory. The instructions may be executable by the at least one processor to cause the apparatus to obtain a set of multiple reference signal measurements corresponding to a plurality of TRPs, the set of multiple reference signal measurements associated with adaptive beam weight generation, select, in accordance with the set of multiple reference signal measurements, one or more first beam weights associated with a first link between one or more antenna panels at the UE and a first TRP of the set of multiple TRPs and one or more second beam weights associated with a second link between the one or more antenna panels at the UE and a second TRP of the set of multiple TRPs, and communicate, via the one or more antenna panels of the UE, with the first TRP using the one or more first beam weights and with the second TRP using the one or more second beam weights.

Another apparatus for wireless communications at a UE is described. The apparatus may include means for obtaining a set of multiple reference signal measurements corresponding to a plurality of TRPs, the set of multiple reference signal measurements associated with adaptive beam weight generation, means for selecting, in accordance with the set of multiple reference signal measurements, one or more first beam weights associated with a first link between one or more antenna panels at the UE and a first TRP of the set of multiple TRPs and one or more second beam weights associated with a second link between the one or more antenna panels at the UE and a second TRP of the set of multiple TRPs, and means for communicating, via the one or more antenna panels of the UE, with the first TRP using the one or more first beam weights and with the second TRP using the one or more second beam weights.

A non-transitory computer-readable medium storing code for wireless communications at a UE is described. The code may include instructions executable by at least one processor to obtain a set of multiple reference signal measurements corresponding to a plurality of TRPs, the set of multiple reference signal measurements associated with adaptive beam weight generation, select, in accordance with the set of multiple reference signal measurements, one or more first beam weights associated with a first link between one or more antenna panels at the UE and a first TRP of the set of multiple TRPs and one or more second beam weights associated with a second link between the one or more antenna panels at the UE and a second TRP of the set of multiple TRPs, and communicating, via the one or more antenna panels of the UE, with the first TRP used the one or more first beam weights and with the second TRP using the one or more second beam weights.

Some examples of the method, apparatuses, and non-transitory computer-readable medium described herein may further include operations, features, means, or instructions for receiving, from the first TRP of the set of multiple TRPs, signaling indicating coordination information associated with aligning one or more time-frequency resources for the communicating.

In some examples of the method, apparatuses, and non-transitory computer-readable medium described herein, the coordination information includes one or more TAEs associated with the first TRP and the second TRP, one or more CFOs associated with the first TRP and the second TRP, or any combination thereof.

In some examples of the method, apparatuses, and non-transitory computer-readable medium described herein, obtaining the set of multiple reference signal measurements may include operations, features, means, or instructions for receiving one or more first reference signals from the first TRP and receiving one or more second reference signals from the second TRP.

In some examples of the method, apparatuses, and non-transitory computer-readable medium described herein, the one or more first reference signals correspond to a first set of time-frequency resources and the one or more second reference signals correspond to a second set of time-frequency resources.

Some examples of the method, apparatuses, and non-transitory computer-readable medium described herein may further include operations, features, means, or instructions for refraining from storing the one or more first beam weights and the one or more second beam weights in radio frequency integrated circuit (RFIC) memory.

In some examples of the method, apparatuses, and non-transitory computer-readable medium described herein, a numerical quantity of a set of multiple reference signals corresponding to the set of multiple reference signal measurements may be based on a numerical quantity of antenna element arrays of the UE.

In some examples of the method, apparatuses, and non-transitory computer-readable medium described herein, the selecting the one or more first beam weights associated with the first link between the one or more antenna panels at the UE and the first TRP and the one or more second beam weights associated with the second link between the one or more antenna panels at the UE and the second TRP may include operations, features, means, or instructions for calculating a set of multiple beam weights based on co-phasing first energy associated with at least one first reference signal measurement corresponding to the first TRP with second energy associated with at least one second reference signal measurement corresponding to the second TRP, the set of multiple reference signal measurements including the at least one first reference signal measurement and the at least one second reference signal measurement, quantizing the set of multiple calculated beam weights based on a beam weight codebook, and projecting the set of multiple quantized beam weights onto the beam weight codebook, where the set of multiple quantized beam weights includes the one or more first beam weights and the one or more second beam weights.

In some examples of the method, apparatuses, and non-transitory computer-readable medium described herein, the set of multiple reference signal measurements include channel state information reference signal (CSI-RS) measurements, synchronization signal block (SSB) reference signal measurements, or both.

A method for wireless communications at a first TRP is described. The method may include transmitting signaling indicating coordination information associated with aligning one or more time-frequency resources for communications corresponding to a set of multiple TRPs, the set of multiple TRPs including the first TRP, transmitting, in accordance with the coordination information, one or more first reference signals associated with an adaptive beam weight generation procedure at a UE, and communicating via one or more beams generated in accordance with the adaptive beam weight generation procedure at the UE.

An apparatus for wireless communications at a first TRP is described. The apparatus may include at least one processor, at least one memory coupled with the at least one processor, and instructions stored in the at least one memory. The instructions may be executable by the at least one processor to cause the apparatus to transmit signaling indicating coordination information associated with aligning one or more time-frequency resources for communications corresponding to a set of multiple TRPs, the set of multiple TRPs including the first TRP, transmit, in accordance with the coordination information, one or more first reference signals associated with an adaptive beam weight generation procedure at a UE, and communicate via one or more beams generated in accordance with the adaptive beam weight generation procedure at the UE.

Another apparatus for wireless communications at a first TRP is described. The apparatus may include means for transmitting signaling indicating coordination information associated with aligning one or more time-frequency resources for communications corresponding to a set of multiple TRPs, the set of multiple TRPs including the first TRP, means for transmitting, in accordance with the coordination information, one or more first reference signals associated with an adaptive beam weight generation procedure at a UE, and means for communicating via one or more beams generated in accordance with the adaptive beam weight generation procedure at the UE.

A non-transitory computer-readable medium storing code for wireless communications at a first TRP is described. The code may include instructions executable by at least one processor to transmit signaling indicating coordination information associated with aligning one or more time-frequency resources for communications corresponding to a set of multiple TRPs, the set of multiple TRPs including the first TRP, transmit, in accordance with the coordination information, one or more first reference signals associated with an adaptive beam weight generation procedure at a UE, and communicate via one or more beams generated in accordance with the adaptive beam weight generation procedure at the UE.

Some examples of the method, apparatuses, and non-transitory computer-readable medium described herein may further include operations, features, means, or instructions for transmitting, to a second TRP of the set of multiple TRPs, a request for first time-frequency resource information associated with one or more second reference signals associated with the second TRP, receiving, in response to the request, a message including the first time-frequency resource information, and determining the coordination information based on the first time-frequency resource information and second time frequency resource information associated with the one or more first reference signals.

Some examples of the method, apparatuses, and non-transitory computer-readable medium described herein may further include operations, features, means, or instructions for transmitting, to a second TRP of the set of multiple TRPs, a message including time-frequency resource information corresponding to the one or more first reference signals.

In some examples of the method, apparatuses, and non-transitory computer-readable medium described herein, the one or more first reference signals may be transmitted using the one or more time-frequency resources, the one or more time-frequency resources corresponding to a set of multiple reference signals including the one or more first reference signals and one or more second reference signals associated with a second TRP of the set of multiple TRPs.

In some examples of the method, apparatuses, and non-transitory computer-readable medium described herein, the coordination information includes one or more TAEs associated with the first TRP, one or more CFOs associated with the first TRP, or any combination thereof.

In some examples of the method, apparatuses, and non-transitory computer-readable medium described herein, a numerical quantity of reference signals in the one or more first reference signals may be based on a numerical quantity of antenna element arrays of the UE.

In some examples of the method, apparatuses, and non-transitory computer-readable medium described herein, the one or more first reference signals include CSI-RSs, SSB reference signals, or both.

### BRIEF DESCRIPTION OF THE DRAWINGS

FIG. 1 shows an example of a wireless communications system that supports generating adaptive beam weights for communications with multiple transmission reception points (TRPs) in accordance with one or more aspects of the present disclosure.

FIG. 2 shows an example of a wireless communications system that supports generating adaptive beam weights for communications with multiple TRPs in accordance with one or more aspects of the present disclosure.

FIG. 3 shows an example of an adaptive beam weight generation procedure that supports generating adaptive beam weights for communications with multiple TRPs in accordance with one or more aspects of the present disclosure.

FIG. 4 shows an example of a process flow that supports generating adaptive beam weights for communications with multiple TRPs in accordance with one or more aspects of the present disclosure.

FIGS. 5 and 6 show block diagrams of devices that support generating adaptive beam weights for communications with multiple TRPs in accordance with one or more aspects of the present disclosure.

FIG. 7 shows a block diagram of a communications manager that supports generating adaptive beam weights for communications with multiple TRPs in accordance with one or more aspects of the present disclosure.

FIG. 8 shows a diagram of a system including a device that supports generating adaptive beam weights for communications with multiple TRPs in accordance with one or more aspects of the present disclosure.

FIGS. 9 and 10 show block diagrams of devices that support generating adaptive beam weights for communications with multiple TRPs in accordance with one or more aspects of the present disclosure.

FIG. 11 shows a block diagram of a communications manager that supports generating adaptive beam weights for communications with multiple TRPs in accordance with one or more aspects of the present disclosure.

FIG. 12 shows a diagram of a system including a device that supports generating adaptive beam weights for communications with multiple TRPs in accordance with one or more aspects of the present disclosure.

FIGS. 13 through 18 show flowcharts illustrating methods that support generating adaptive beam weights for communications with multiple TRPs in accordance with one or more aspects of the present disclosure.

### DETAILED DESCRIPTION

In some wireless communications systems, a user equipment (UE) may communicate with a transmission reception point (TRP) using one or more directional beams. Each directional beam may correspond to a set of weights applied to a set of antenna elements, where these weights may control a phase or amplitude of each antenna element. The UE may select the one or more weights for the directional beams from a preconfigured codebook of beam weights. However, beams selected from such codebooks may be susceptible to changing environments (e.g., partial blockage), and thus may result in relatively lower quality of communications than dynamic/adaptive beam weights, which may be calculated in real-time or in mission-mode operations. Accordingly, in some systems, the UE may perform beam measurements using channel sensing beams and may calculate adaptive beam weights using the beam measurements. In some examples, the UE may concurrently communicate with multiple TRPs using a same antenna panel of the UE. In such examples, the UE may be unable to perform coherent adaptive beam weight generation due to timing alignment errors (TAEs) and carrier frequency offsets (CFOs) between the multiple TRPs.

Accordingly, techniques described herein may provide for the UE to adaptively generate beam weights for use in communications with multiple TRPs at a single antenna panel of the UE. For example, the UE may perform reference signal measurements using reference signals from multiple TRPs. The UE may use the reference signal measurements to select adaptive beam weights. For example, the UE may calculate beam weights by co-phasing energy of the reference signals from different TRPs, quantizing the calculated beam weights using a beam weight codebook, and projecting the quantized beam weights onto the codebook. The UE may generate beams using the selected beam weights to receive and/or transmit signaling from or to the multiple TRPs, respectively. In some cases, the TRPs may indicate coordination information, such as TAEs and CFOs, such that the UE may receive the reference signals from the multiple TRPs at an antenna panel using same time-frequency resources.

Aspects of the disclosure are initially described in the context of wireless communications systems. Aspects of the disclosure are further illustrated by and described with reference to adaptive beam weight generation procedures and process flow diagrams. Aspects of the disclosure are further illustrated by and described with reference to apparatus diagrams, system diagrams, and flowcharts that relate to generating adaptive beam weights for communications with multiple TRPs.

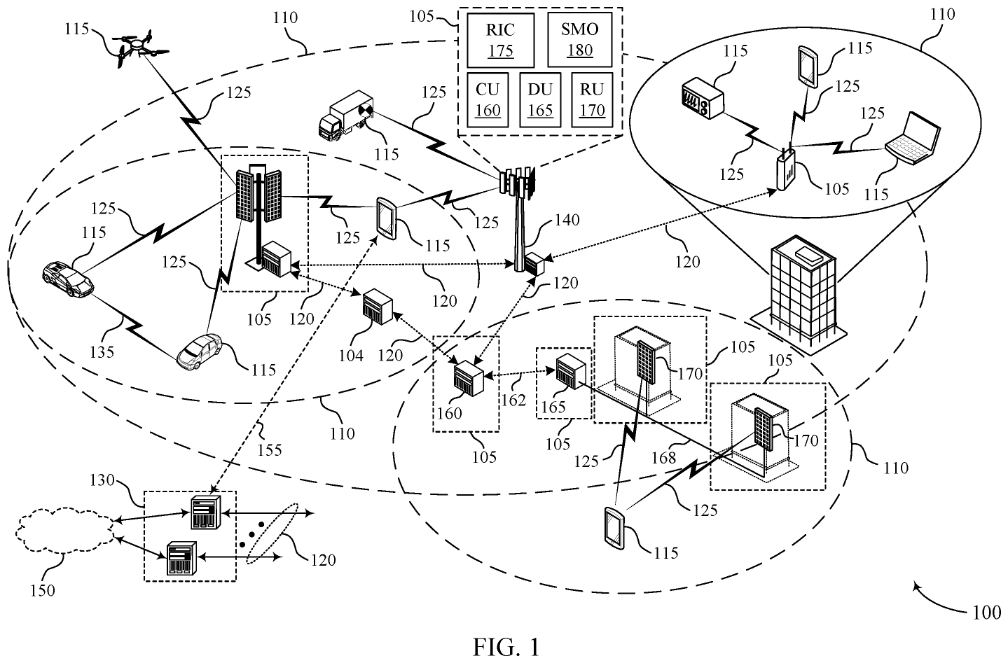

FIG. 1 shows an example of a wireless communications system 100 that supports generating adaptive beam weights for communications with multiple TRPs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support generating adaptive beam weights for communications with multiple TRPs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In the wireless communications system 100, a network entity 105 may communicate with a UE 115 via one or more TRPs. For example, the wireless communications system 100 may include multiple TRPs positioned at various geographical locations. The TRPs may be communicate with one or more network entities 105, such as base stations 104 of the wireless communications system 100. In some other examples, the TRPs may perform the functionalities of one or more network entities 105. In some cases, the TRPs may communicate with UEs 115 in the wireless communications system 100. A network entity 105 may use more than one TRP to communicate with a UE, which may be referred to as multi-TRP (mTRP) communications. For mTRP communications, a network entity 105 may define one or more clusters of TRPs to serve one or more UEs 115. For example, one or more network entities 105 may coordinate with each other to schedule a cluster of TRPs to transmit a downlink transmission to a UE 115.

In some examples, the network entity 105 may transmit or receive signaling to or from the UE 115 via a first TRP and a second TRP. In some cases, the UE 115 may communicate with the network entity 105 via the first TRP at a first antenna panel of the UE 115 and via the second TRP at a second antenna panel of the UE 115. In some examples, the UE 115 may communicate via both of the first TRP and the second TRP at a single antenna panel of the UE 115. For example, the UE 115 may use a multi-beam (e.g., a beam with multiple lobes at a single antenna panel) to communicate via the first TRP and the second TRP.

In some examples, the UE 115 may adaptively generate beam weights for use in communications with multiple TRPs at a single antenna panel of the UE 115. For example, the UE 115 may perform reference signal measurements using reference signals (e.g., channel state information-reference signals (CSI-RSs), synchronization signal blocks (SSBs), sounding reference signals (SRSs), or any combination) from multiple TRPs. The UE 115 may use the reference signal measurements to select adaptive beam weights. For example, the UE 115 may calculate beam weights by co-phasing energy of the reference signals from different TRPs, quantizing the calculated beam weights using a beam weight codebook, and projecting the quantized beam weights onto the codebook. The UE 115 may generate beams using the selected beam weights to receive signaling from multiple TRPs, transmit signaling to multiple TRPs, or both. In some cases, the TRPs may indicate coordination information, such as TAEs and CFOs, such that the UE 115 may receive the reference signals from the multiple TRPs at an antenna panel using same time-frequency resources.

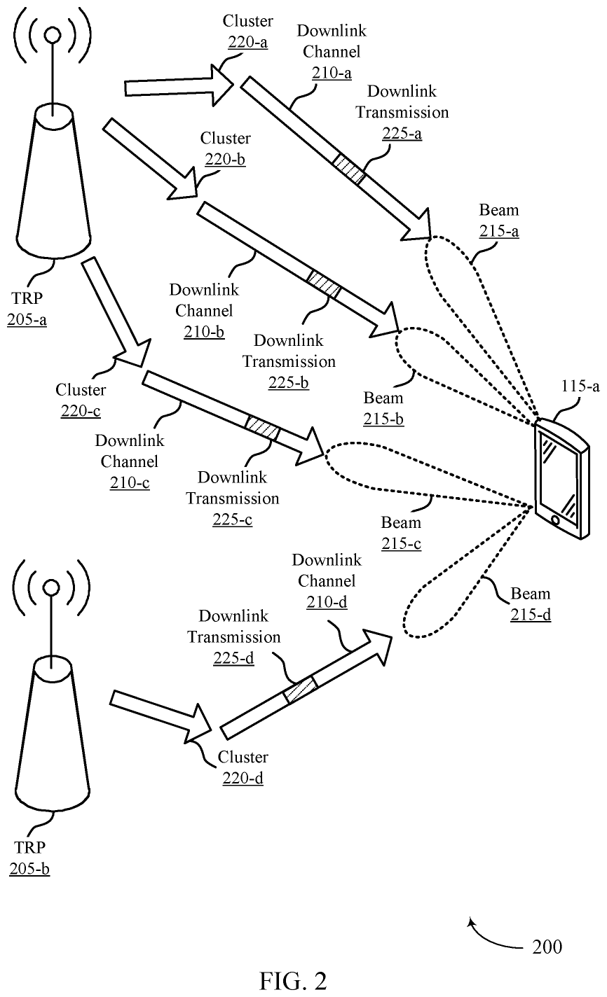

FIG. 2 shows an example of a wireless communications system 200 that supports generating adaptive beam weights for communications with multiple TRPs in accordance with one or more aspects of the present disclosure. The wireless communications system 200 may implement aspects of or may be implemented by aspects of the wireless communications system 100. For example, the wireless communications system 200 may include a UE 115-a, a TRP 205-a, and a TRP 205-b, which may be examples of the corresponding devices as described with reference to FIG. 1.

In some examples, the wireless communications system 200 may support mmW communications between a UE 115-a, a TRP 205-a, and a TRP 205-b. Some mmW systems may operate in carrier frequencies such as 28 to 39 GHz. Some mmW systems may operate in upper mmW frequency bands and sub-terahertz frequency bands (e.g., 52.6 GHz to 114.25 GHZ, and beyond). In such systems, the UE 115-a, the TRP 205-a, and the TRP 205-b may communicate using beamforming applications (e.g., analog, digital, or hybrid beamforming) to generate directional beams 215. That is, the UE 115-a may generate the directional beams 215 by steering energy in specific directions (e.g., directions in beam-space). Each directional beam 215 may have a weight applied to an antenna element of the antenna array, which may control a phase of the directional beam, an amplitude of the directional beam, or both. The UE 115-a may select one or more weights for the directional beams 215 from a static codebook (e.g., a preconfigured set of beams, beam weights, and/or beam codewords for the UE 115-a to use) of beam weights which may be stored in a radio frequency integrated circuit (RFIC) memory of the UE 115-a.

In such systems, a quality (e.g., a performance quality) of mmW communications may depend on the codebook and a beam selected from the codebook by the UE 115-a. For example, the UE 115-a may select a first directional beam 215 from the codebook with a first beam weight which may result in a relatively lower quality of communications (e.g., a lower output peak power to mean noise power ratio) than a second directional beam 215 with a second beam weight. That is, the first directional beam 215 may have more noise as compared to a signal strength of an intended transmission as compared to the second directional beam 215, which may result in less reliable communications. Additionally, the directional beams 215 from the static codebook may be limited. That is, the UE 115-a selecting the directional beams 215 from the static codebook may be unable to quickly change to a different directional beam 215 to respond to changing environments (e.g., partial blockage), which may result in a lower quality of communications.

Accordingly, the UE 115-a may generate adaptive beam weights (e.g., a general set of dynamic, adaptive, or flexible beam weights) for directional beams 215. That is, rather than selecting beam weights for the directional beam 215 from the static codebook (e.g., a priori beam weights stored in the RFIC memory of the UE 115-a), the UE 115-a may generate or learn adaptive beam weights in real time. As described herein, adaptive beam weights may refer to a set of beam weights (e.g., phase shifts and amplitude values) which the UE 115-a may use over antenna elements in an antenna array. The adaptive beam weights may come from a quantization set of phase shifts and amplitudes. In contrast to a codebook of pre-stored beam weights (e.g., the static codebook) where the amplitude and phase shift relationships across the antenna elements may be used to steer the energy of the beam towards fixed/pre-determined directions in the beam-space, the adaptive beam weights may exercise multiple (e.g., all) possible phase shift and amplitude values in the quantization space. For example, if the UE 115-a has N antenna elements in an antenna array, a B-bit phase shifter and a B₁-bit amplitude control, there may be (2^{B})^{N-1}*(2^{B}^{₁})^{N} beam weight possibilities. For example, for N=4, B=3 and B₁=3, there may be 2,097,152 possible beam weights.

Accordingly, the UE 115-a may not store all possible beam weights in a low-complexity low-latency memory of the UE 115-a, such as the RFIC memory of the UE 115-a. In contrast, a size of a codebook of steered beams may be relatively small (e.g., 2N+1=9 beams in the previous example). The UE 115-a may store the 9 beams in the RFIC memory and may quickly access the 9 beams, making the use of static codebook-based beamforming the scheme of lowest complexity in practical implementations. In addition to storage issues, synthesizing or determining the correct set of adaptive beam weights may be performed in mission-mode operations of the UE 115-a. For example, the UE 115-a may make phase and/or signal strength estimates across the antenna elements of the antenna array. The UE 115-a may perform these mission-mode operations over SSBs, CSI-RSs, or SRSs.

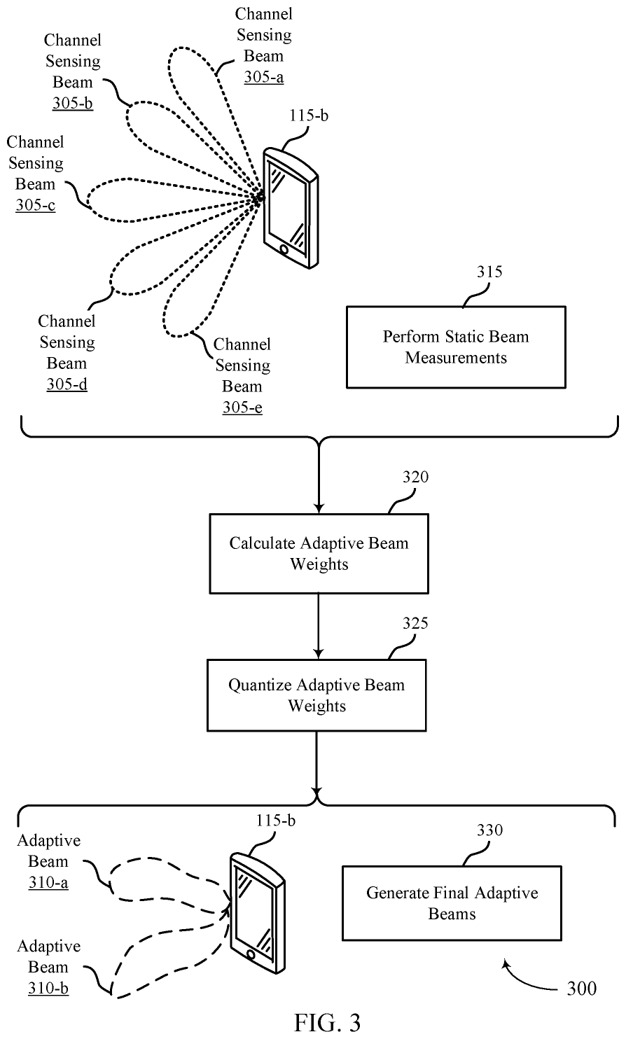

In some mTRP scenarios, the UE 115-a may generate adaptive beam weights at a first panel of the UE 115-a for communication with a single TRP 205 (e.g., the TRP 205-a) using multiple clusters 220 belonging to a same channel between the UE 115-a and the TRP 205. As described herein, a cluster may refer to one or more channel obstructions which may direct a beam (antenna elements of panels at a TRP 205, reflectors, relays of TRPs 205, etc.). For example, the UE 115-a may receive one or more downlink transmissions (e.g., a downlink transmission 225-a and a downlink transmission 225-b), such as SSBs, CSI-RSs, or SRSs, from the TRP 205-a via one or more downlink channels 210. The TRP 205-a may transmit the downlink transmission 225-a and the downlink transmission 225-b via a downlink channel 210-a and a downlink channel 210-b using a cluster 220-a and a cluster 220-b, respectively. The UE 115-a may receive the downlink transmission 225-a and the downlink transmission 225-b at a first panel of the UE 115-a using directional beams 215 from the static codebook and may perform an adaptive beam weight generation procedure to generate an adaptive beam 215-a and an adaptive beam 215-b at the first panel (e.g., a multi-beam). That is, the UE 115-a may co-phase (e.g., combine) energy from the downlink transmission 225-a and the downlink transmission 225-b. The adaptive beam weight generation procedure is described in further detail with reference to FIG. 3. The UE 115-a may use the adaptive beam 215-a and the adaptive beam 215-b at the first panel to communicate (e.g., to communicate uplink and downlink transmissions) with the TRP 205-a via the cluster 220-a and the cluster 220-b.

Such adaptive beam weight techniques may allow for the UE 115-a to communicate with the TRP 205-a over a wider range of angular spreads via a same cluster (e.g., the cluster 220-a or the cluster 220-b) as compared to static codebook techniques. Additionally, or alternatively, adaptive beam weight generation may provide for multi-beam effects such as the UE 115-a communicating with the TRP 205-a using multiple lobes (e.g., multiple beams in different directions in beam-space) across multiple clusters 220 using a same antenna panel of the UE 115-a. Such techniques may further allow the UE 115-a to control side lobes of beams (e.g., change a size or direction of radiation of signals which are not part of an intended lobe) to increase a quality of communications with the TRP 205-a. The UE 115-a may additionally, or alternatively, account for impairments (e.g., from hand blockage of a user of the UE 115-a or polarization-specific impairments due to housing, materials, or sensors of the UE 115-a), and may thus increase a reliability of communications as compared to beam weights from the static codebook.

However, in some mTRP scenarios, the UE 115-a may communicate with both of the TRP 205-a and the TRP 205-b at a same panel at the UE 115-a. That is, the UE 115-a may receive a downlink transmission 225-c via a downlink channel 210-c via a cluster 220-c of the TRP 205-a and a downlink transmission 225-d via a downlink channel 210-d via a cluster 220-d of the TRP 205-b at a second panel of the UE 115-a. In such scenarios, the UE 115-a may co-phase energy from the downlink transmission 225-c and the downlink transmission 225-b. However, because the cluster 220-c and the cluster 220-d are from different TRPs (e.g., the TRP 205-a and the TRP 205-b, respectively), the UE 115-a may co-phase energy from the downlink transmission 225-c and the downlink transmission 225-d incoherently. That is, to co-phase the energy from the downlink transmission 225-c and the downlink transmission 225-d coherently, the UE 115-a may account for TAEs and CFO mismatches between the TRP 205-a and the TRP 205-b (e.g., from local oscillator mismatches and mobility). However, the TRP 205-a and the TRP 205-b may not communicate TAEs and CFO mismatches to the UE 115-a (e.g., even in a coherent joint transmission mode), and thus the UE 115-a may be unable to account for the TAEs and CFO mismatches. In some examples, incoherent co-phasing may result in a reduced quality of communication (e.g., performance losses) which may be relatively more reduced as compared to a quality of communication using the static codebook.

Accordingly, techniques described herein may allow for the UE 115-a to coherently co-phase energy in mTRP settings in a coordinated joint transmission framework. That is, the UE 115-a may co-phase energy from the cluster 220-c and the cluster 220-d associated with the TRP 205-a and the TRP 205-b at the second antenna panel of the UE 115-a to generate an adaptive beam 215-c and an adaptive beam 215-d at the second antenna panel (e.g., a multi-beam).

In some implementations, the TRP 205-a and the TRP 205-b may implement signaling to enable adaptive beam weights in mTRP settings. For example, the TRP 205-a and the TRP 205-b may indicate TAEs and CFOs to the UE 115-a to enable the UE 115-a to co-phase energy from clusters 220 from both the TRP 205-a and the TRP 205-b. In some examples, the TRP 205-a and the TRP 205-b may communicate (e.g., via backhaul signaling) to determine a TAE and/or a CFO between the TRP 205-a and the TRP 205-b. The TRP 205-a and the TRP 205-b may accordingly each transmit, to the UE 115-a, an indication of the TAE and/or the CFO. The UE 115-a may thus coherently co-phase energy from the cluster 220-c and the cluster 220-d to generate the adaptive beam 215-c and the adaptive beam 215-d at the second panel for communication with the TRP 205-a and the TRP 205-b, respectively.

In some examples, the UE 115-a may perform adaptive beam weight learning based on reference signal measurements, such as SSB measurements or any other type of reference signal measurements. That is, the UE 115-a may use channel sensing beams to estimate a channel impulse response and thus calculate the adaptive beam weights. However, because the UE 115-a may receive reference signals periodically (e.g., with a periodicity of 20 ms), performing adaptive beam weight learning with periodic reference signals may incur latency and thus may reduce an effectiveness of adaptive beam weight generation in mobility scenarios or with large antenna arrays. Thus, to reduce latency, the UE 115-a may perform adaptive beam weight learning based on measurements of reference signals that may not be periodic, such as CSI-RSs transmitted (e.g., granted) by the TRP 205-a and the TRP 205-b.

Accordingly, the TRP 205-a and the TRP 205-b may transmit coordinated CSI-RSs to the UE 115-a to enable adaptive beam weight learning at the UE 115-a. For example, the TRP 205-a and the TRP 205-b may coordinate a transmission of CSI-RSs in same time and frequency resources (e.g., via the downlink channel 210-c and the downlink channel 210-b, respectively). The UE 115-a may perform one or more measurements of the coordinated CSI-RSs to generate the adaptive beam 215-c and the adaptive beam 215-d.

In some examples, if the UE 115-a has N antenna element arrays, the TRP 205-a and the TRP 205-b may each transmit N coordinated CSI-RSs to the UE 115-a (e.g., for a low-complexity adaptive beam weight estimate). In some examples (e.g., for a higher-complexity adaptive beam weight estimate), the TRP 205-a and the TRP 205-b may each transmit KN coordinated CSI-RSs the UE 115-a, where K>1. A low-complexity adaptive beam weight estimate (e.g., with N coordinated CSI-RSs) may result in relatively higher latency and a relatively lower quality of performance than a higher-complexity adaptive beam weight estimate (e.g., with KN coordinated CSI-RSs). For example, to perform the low-complexity adaptive beam weight estimate, the UE 115-a may measure and co-phase energy from a lower numerical quantity of reference signals, which may decrease processing and latency as compared to the higher-complexity adaptive beam weight estimate with a greater numerical quantity of reference signals. However, as a result of measuring and co-phasing energy from fewer reference signals, the UE 115-a may generate a less accurate adaptive beam weight estimate (e.g., associated with a lower output peak power to mean noise power ratio) as compared to the higher-complexity adaptive beam weight estimate.

FIG. 3 shows an example of an adaptive beam weight generation procedure 300 that supports generating adaptive beam weights for communications with multiple TRPs in accordance with one or more aspects of the present disclosure. The adaptive beam weight generation procedure 300 may implement aspects of or may be implemented by aspects of the wireless communications system 100 or the wireless communications system 200. For example, the adaptive beam weight generation procedure 300 may include a UE 115-b, which may be examples of the corresponding devices as described with reference to FIGS. 1 and 2.

At 315, a UE 115-b may perform one or more static beam measurements at an antenna panel of the UE 115-b. That is, the UE 115-b may receive one or more downlink transmissions (e.g., SSBs, CSI-RSs, or SRSs) from one or more TRPs. The UE 115-b may perform the static beam measurements using directional channel sensing beams 305, such as a channel sensing beam 305-a, a channel sensing beam 305-b, a channel sensing beam 305-c, a channel sensing beam 305-d, and a channel sensing beam 305-e. The channel sensing beams 305 may be designed a priori (e.g., determined prior to mission-mode operations rather than learned in real time), and may be stored in an RFIC memory of the UE 115-b. The UE 115-b may perform the one or more static beam measurements by co-phasing energy measured from each of the channel sensing beams 305 (e.g., from multiple clusters of one or more TRPs). The one or more static beam measurements may allow the UE 115-b to determine a channel impulse response of the antenna panel.

At 320, the UE 115-b may perform one or more adaptive beam weight calculations. For example, the UE 115-b may use the one or more static beam measurements to calculate one or more adaptive beam weights. The calculation may include implementing a matched filter that generates an output signal with a relatively large output peak power to mean noise power ratio as compared to other filters, where the output signal may be referred to as g_{ideal}. In some examples, g_{ideal} may represent a set of adaptive beam weights (e.g., a set of beam phases and/or amplitudes) and may be larger than beam weights from a codebook. Accordingly, the UE 115-b may refrain from storing g_{ideal} in the RFIC memory of the UE 115-b.

At 325, the UE 115-b may quantize the one or more adaptive beam weights. For example, the UE 115-b may map g_{ideal} onto one or more discrete beam weight values from a beam weight codebook. The UE 115-b may project the quantized adaptive beam weights onto the beam weight codebook (e.g., a limited codebook extension stored in the RFIC memory of the UE 115-b) to generate an adaptive beam weight for the UE 115-b to use, which may be referred to as g_{used}.

At 330, the UE 115-b may generate adaptive beams 310 for the UE 115-b to use at the antenna panel, such as the adaptive beam 310-a and the adaptive beam 310-b. The adaptive beams 310 may be a multi-beam (e.g., multiple beams communicating via multiple clusters at a single antenna panel). The UE 115-b may generate the adaptive beams 310 using the adaptive beam weight g_{used}. The UE 115-b may accordingly communicate with the one or more TRPs at the antenna panel using adaptive beams 310 which account for blockage (e.g., partial or total blockage from a hand of a user or a changing environment), wide angular spread, or other factors which may otherwise decrease a quality of communication.

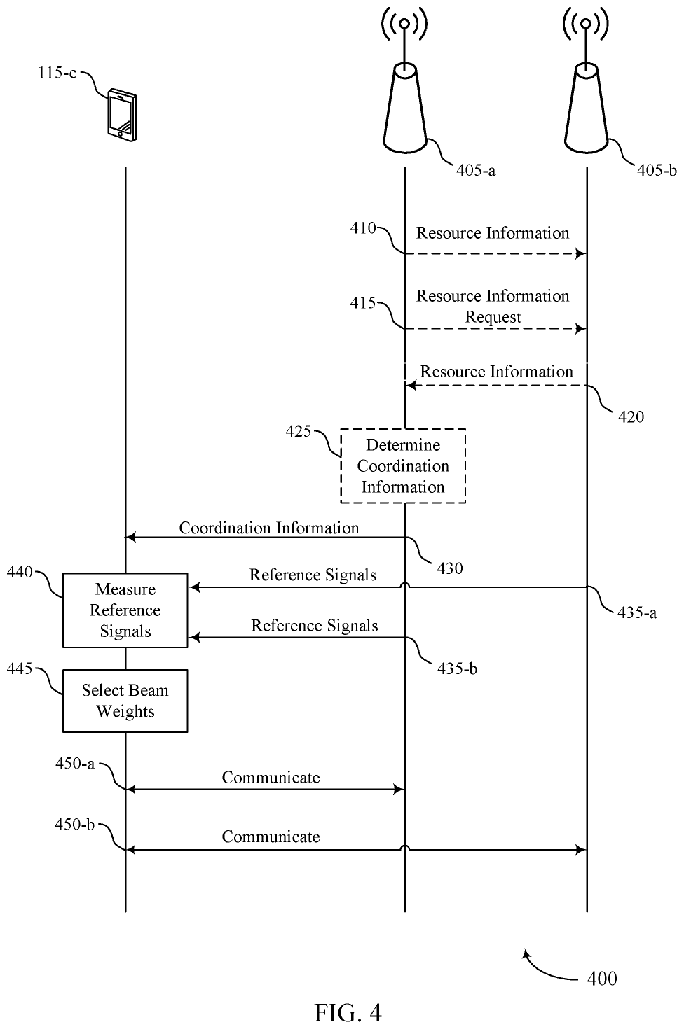

FIG. 4 shows an example of a process flow 400 that supports generating adaptive beam weights for communications with multiple TRPs in accordance with one or more aspects of the present disclosure. The process flow 400 may implement aspects of or may be implemented by aspects of the wireless communications system 100, the wireless communications system 200, or the adaptive beam weight generation procedure 300. For example, the process flow 400 may include a UE 115 (e.g., a UE 115-c) and a TRP 405 (e.g., a TRP 405-a and a TRP 405-b), which may be examples of the corresponding devices as described with reference to FIG. 1.

In the following description of the process flow 400, the operations between the UE 115-c, the TRP 405-a, and the TRP 405-b may be transmitted in a different order than the example order shown. Some operations may also be omitted from the process flow 400, and other operations may be added to the process flow 400. Further, although some operations or signaling may be shown to occur at different times for discussion purposes, these operations may actually occur at the same time.

At 410, the TRP 405-a may transmit a message to the TRP 405-b including first time-frequency resource information corresponding to one or more reference signals. For example, the TRP 405-a may transmit a message including one or more first time/frequency resources over which the TRP 405-a may transmit reference signals (e.g., CSI-RSs) to the UE 115-c.

At 415, the TRP 405-a may transmit, to the TRP 405-b, a request for second time-frequency resource information associated with one or more reference signals. For example, the TRP 405-a may transmit a request for second time-frequency resources over which the TRP 405-b may transmit reference signals (e.g., CSI-RSs) to the UE 115-c. At 420, the TRP 405-b may transmit a message to the TRP 405-a including the second time-frequency resource information in response to the request.

At 425, the TRP 405-a may determine coordination information using the first time-frequency resource information and the second time-frequency resource information. For example, the TRP 405-a may determine one or more TAEs, CFOs, or both between the TRP 405-a and the TRP 405-b using the first time-frequency resource information and the second time-frequency resource information.

At 430, the TRP 405-a may transmit signaling to the UE 115-c indicating the coordination information (e.g., the one or more TAEs and/or CFOs). In some examples, the coordination information may allow the UE 115-a to align one or more time-frequency resources for communicating with the TRP 405-a and the TRP 405-b.

At 435-a and 435-b, the TRP 405-a and the TRP 405-b, respectively, may transmit reference signals (e.g., CSI-RSs and/or SSBs) to the UE 115-c. For example, the TRP 405-a may transmit one or more first reference signals over a first set of time-frequency resources and the TRP 405-b may transmit one or more second reference signals over a second set of time-frequency resources. In some examples, the first set of time-frequency resources and the second set of time-frequency resources may be the same. In some examples, a numerical quantity of reference signals transmitted by the TRP 405-a and the TRP 405-b may be a multiple of a numerical quantity of antenna element arrays of the UE 115-c.

At 440, the UE 115-c may receive the one or more first reference signals and the one or more second reference signals and may obtain a measurement of the one or more first reference signals and the one or more second reference signals. For example, the UE 115-c may perform one or more measurements of the one or more first reference signals and the one or more second reference signals to adaptively generate one or more beam weights for communications with the TRP 405-a and the TRP 405-b. The one or more measurements may include at least one first reference signal measurement of the one or more first reference signals and at least one second reference signal measurement of the one or more second reference signals

At 445, the UE 115-c may select one or more beam weights for communications at one or more antenna panels of the UE 115-c via a first link with the TRP 405-a and a second link with the TRP 405-b. For example, the UE 115-c may calculate one or more beam weights by co-phasing first energy associated with the at least one first reference signal measurement of the one or more first reference signals and second energy associated with the at least one second reference signal measurement of the one or more second reference signals. The UE 115-c may quantize the one or more calculated beam weights using a beam weight codebook. The UE 115-c may project the one or more quantized beam weights onto the beam weight codebook. The UE 115-c may select one or more first beam weights and one or more second beam weights of the quantized beam weights for communication via the first link with the TRP 405-a and via the second link with the TRP 405-b.

At 450-a and 450-b, the UE 115-c may communicate with the TRP 405-a and the TRP 405-b, respectively. For example, the UE 115-c may communicate with the TRP 405-a at one or more first antenna panels of the UE 115-c using the one or more first beam weights. The UE 115-c may communicate with the TRP 405-b at one or more second antenna panels of the UE 115-c using the one or more second beam weights. In some examples, the one or more first antenna panels of the UE 115-c and the one or more second antenna panels of the UE 115-c may be same one or more antenna panels.

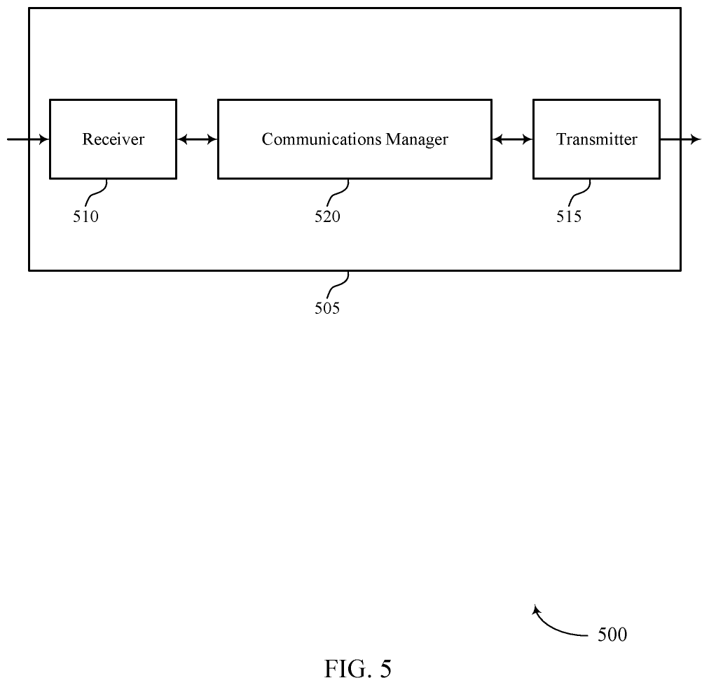

FIG. 5 shows a block diagram 500 of a device 505 that supports generating adaptive beam weights for communications with multiple TRPs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to generating adaptive beam weights for communications with multiple TRPs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to generating adaptive beam weights for communications with multiple TRPs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of generating adaptive beam weights for communications with multiple TRPs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for obtaining a set of multiple reference signal measurements corresponding to a set of TRPs, the set of multiple reference signal measurements associated with adaptive beam weight generation. The communications manager 520 is capable of, configured to, or operable to support a means for selecting, in accordance with the set of multiple reference signal measurements, one or more first beam weights associated with a first link between one or more antenna panels at the UE and a first TRP of the set of multiple TRPs and one or more second beam weights associated with a second link between the one or more antenna panels at the UE and a second TRP of the set of multiple TRPs. The communications manager 520 is capable of, configured to, or operable to support a means for communicating, via the one or more antenna panels of the UE, with the first TRP using the one or more first beam weights and with the second TRP using the one or more second beam weights.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for generating adaptive beam weights for communications with multiple TRPs, which may allow for an improved quality of communication.

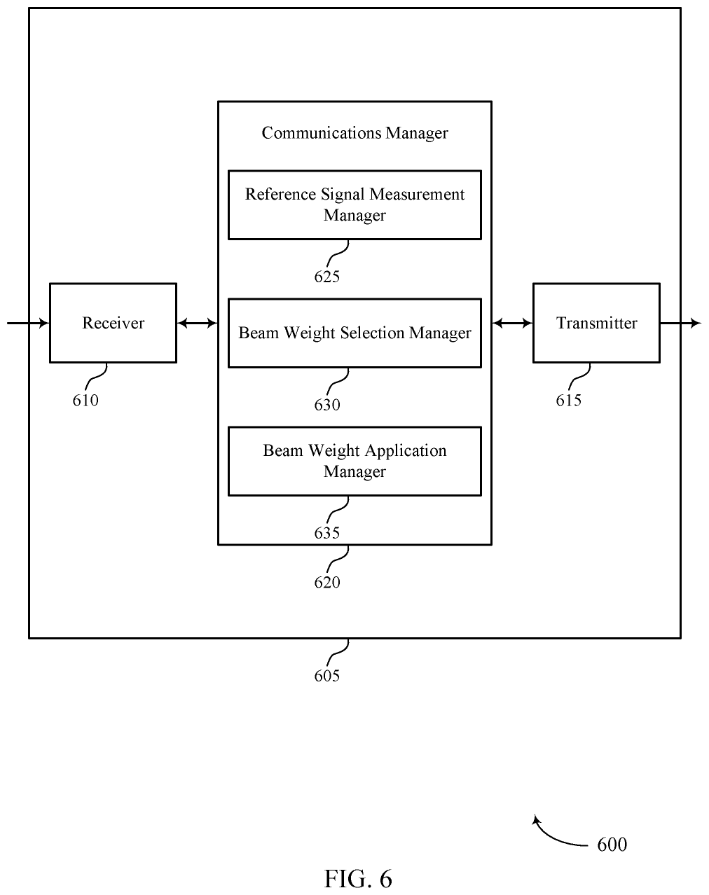

FIG. 6 shows a block diagram 600 of a device 605 that supports generating adaptive beam weights for communications with multiple TRPs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to generating adaptive beam weights for communications with multiple TRPs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to generating adaptive beam weights for communications with multiple TRPs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of generating adaptive beam weights for communications with multiple TRPs as described herein. For example, the communications manager 620 may include a reference signal measurement manager 625, a beam weight selection manager 630, a beam weight application manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The reference signal measurement manager 625 is capable of, configured to, or operable to support a means for obtaining a set of multiple reference signal measurements corresponding to a set of TRPs, the set of multiple reference signal measurements associated with adaptive beam weight generation. The beam weight selection manager 630 is capable of, configured to, or operable to support a means for selecting, in accordance with the set of multiple reference signal measurements, one or more first beam weights associated with a first link between one or more antenna panels at the UE and a first TRP of the set of multiple TRPs and one or more second beam weights associated with a second link between the one or more antenna panels at the UE and a second TRP of the set of multiple TRPs. The beam weight application manager 635 is capable of, configured to, or operable to support a means for communicating, via the one or more antenna panels of the UE, with the first TRP using the one or more first beam weights and with the second TRP using the one or more second beam weights.

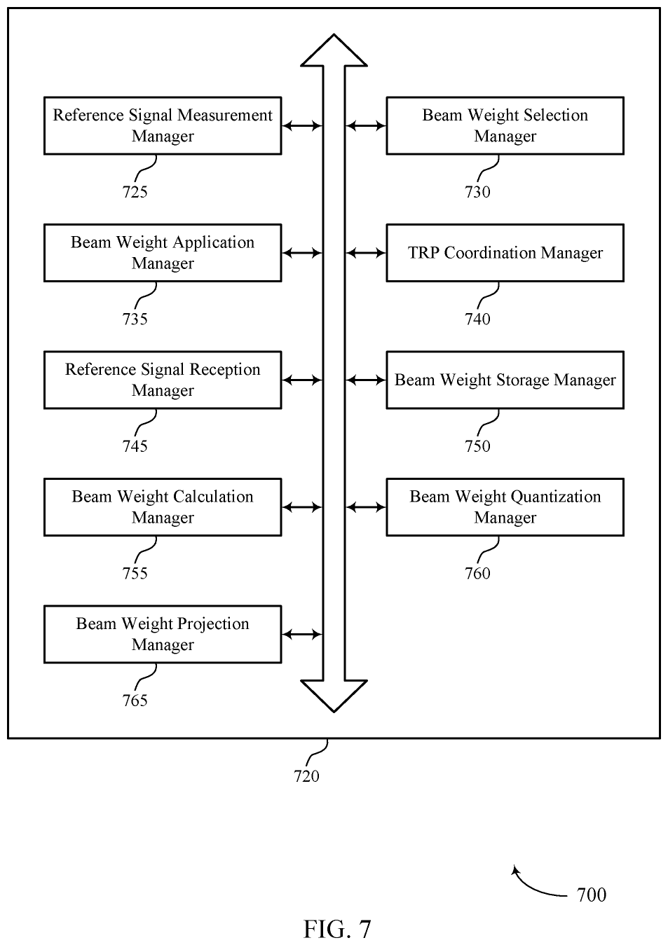

FIG. 7 shows a block diagram 700 of a communications manager 720 that supports generating adaptive beam weights for communications with multiple TRPs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of generating adaptive beam weights for communications with multiple TRPs as described herein. For example, the communications manager 720 may include a reference signal measurement manager 725, a beam weight selection manager 730, a beam weight application manager 735, an TRP coordination manager 740, a reference signal reception manager 745, a beam weight storage manager 750, a beam weight calculation manager 755, a beam weight quantization manager 760, a beam weight projection manager 765, or any combination thereof. Each of these components, or components or subcomponents thereof (e.g., one or more processors, one or more memories), may communicate, directly or indirectly, with one another (e.g., via one or more buses).

The communications manager 720 may support wireless communications at a UE in accordance with examples as disclosed herein. The reference signal measurement manager 725 is capable of, configured to, or operable to support a means for obtaining a set of multiple reference signal measurements corresponding to a set of TRPs, the set of multiple reference signal measurements associated with adaptive beam weight generation. The beam weight selection manager 730 is capable of, configured to, or operable to support a means for selecting, in accordance with the set of multiple reference signal measurements, one or more first beam weights associated with a first link between one or more antenna panels at the UE and a first TRP of the set of multiple TRPs and one or more second beam weights associated with a second link between the one or more antenna panels at the UE and a second TRP of the set of multiple TRPs. The beam weight application manager 735 is capable of, configured to, or operable to support a means for communicating, via the one or more antenna panels of the UE, with the first TRP using the one or more first beam weights and with the second TRP using the one or more second beam weights.

In some examples, the TRP coordination manager 740 is capable of, configured to, or operable to support a means for receiving, from the first TRP of the set of multiple TRPs, signaling indicating coordination information associated with aligning one or more time-frequency resources for the communicating.

In some examples, the coordination information includes one or more TAEs associated with the first TRP and the second TRP, one or more CFOs associated with the first TRP and the second TRP, or any combination thereof.

In some examples, to support obtaining the set of multiple reference signal measurements, the reference signal reception manager 745 is capable of, configured to, or operable to support a means for receiving one or more first reference signals from the first TRP. In some examples, to support obtaining the set of multiple reference signal measurements, the reference signal reception manager 745 is capable of, configured to, or operable to support a means for receiving one or more second reference signals from the second TRP.

In some examples, the one or more first reference signals correspond to a first set of time-frequency resources. In some examples, the one or more second reference signals correspond to a second set of time-frequency resources.

In some examples, the beam weight storage manager 750 is capable of, configured to, or operable to support a means for refraining from storing the one or more first beam weights and the one or more second beam weights in RFIC memory of the UE.

In some examples, a numerical quantity of a set of multiple reference signals corresponding to the set of multiple reference signal measurements is based on a numerical quantity of antenna element arrays of the UE.

In some examples, to support selecting the one or more first beam weights associated with the first link between the one or more antenna panels at the UE and the first TRP and one or more second beam weights associated with the second link between the one or more antenna panels at the UE and the second TRP, the beam weight calculation manager 755 is capable of, configured to, or operable to support a means for calculating a set of multiple beam weights based on co-phasing first energy associated with at least one first reference signal measurement corresponding to the first TRP with second energy associated with at least one second reference signal measurement corresponding to the second TRP, the set of multiple reference signal measurements including the at least one first reference signal measurement and the at least one second reference signal measurement. In some examples, to support selecting the one or more first beam weights associated with the first link between one or more antenna panels at the UE and the first TRP and one or more second beam weights associated with the second link between the one or more antenna panels at the UE and the second TRP, the beam weight quantization manager 760 is capable of, configured to, or operable to support a means for quantizing the set of multiple calculated beam weights based on a beam weight codebook. In some examples, to support selecting the one or more first beam weights associated with the first link between the one or more antenna panels at the UE and the first TRP and one or more second beam weights associated with the second link between the one or more antenna panels at the UE and the second TRP, the beam weight projection manager 765 is capable of, configured to, or operable to support a means for projecting the set of multiple quantized beam weights onto the beam weight codebook, where the set of multiple quantized beam weights includes the one or more first beam weights and the one or more second beam weights.

In some examples, the set of multiple reference signal measurements include CSI-RS measurements, SSB reference signal measurements, or both.

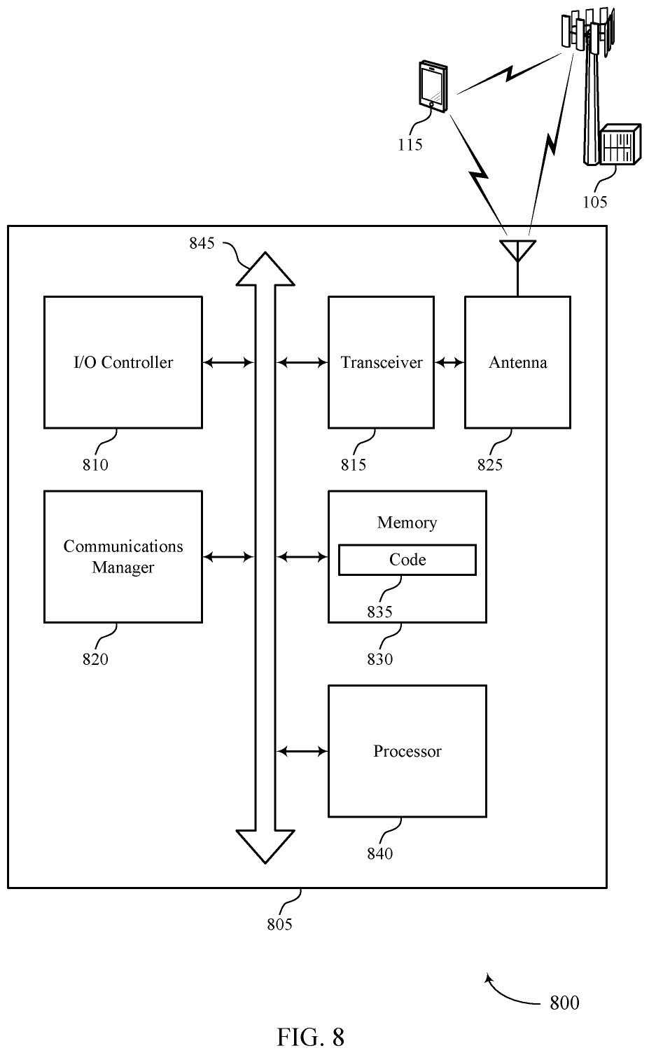

FIG. 8 shows a diagram of a system 800 including a device 805 that supports generating adaptive beam weights for communications with multiple TRPs in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting generating adaptive beam weights for communications with multiple TRPs). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 is capable of, configured to, or operable to support a means for obtaining a set of multiple reference signal measurements corresponding to a set of TRPs, the set of multiple reference signal measurements associated with adaptive beam weight generation. The communications manager 820 is capable of, configured to, or operable to support a means for selecting, in accordance with the set of multiple reference signal measurements, one or more first beam weights associated with a first link between one or more antenna panels at the UE and a first TRP of the set of multiple TRPs and one or more second beam weights associated with a second link between the one or more antenna panels at the UE and a second TRP of the set of multiple TRPs. The communications manager 820 is capable of, configured to, or operable to support a means for communicating, via the one or more antenna panels of the UE, with the first TRP using the one or more first beam weights and with the second TRP using the one or more second beam weights.

By including or configuring the communications manager 820 in accordance with examples as described herein, the device 805 may support techniques for generating adaptive beam weights for communications with multiple TRPs, which may allow for improved communication reliability, reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of generating adaptive beam weights for communications with multiple TRPs as described herein, or the processor 840 and the memory 830 may be otherwise configured to perform or support such operations.

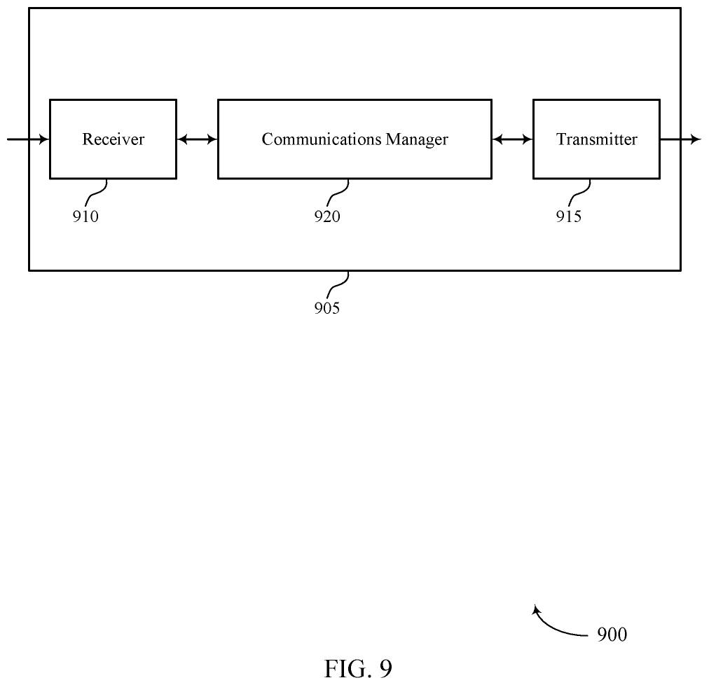

FIG. 9 shows a block diagram 900 of a device 905 that supports generating adaptive beam weights for communications with multiple TRPs in accordance with one or more aspects of the present disclosure. The device 905 may be an example of aspects of an TRP as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of generating adaptive beam weights for communications with multiple TRPs as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first TRP in accordance with examples as disclosed herein. For example, the communications manager 920 is capable of, configured to, or operable to support a means for transmitting signaling indicating coordination information associated with aligning one or more time-frequency resources for communications corresponding to a set of multiple TRPs, the set of multiple TRPs including the first TRP. The communications manager 920 is capable of, configured to, or operable to support a means for transmitting, in accordance with the coordination information, one or more first reference signals associated with an adaptive beam weight generation procedure at a UE. The communications manager 920 is capable of, configured to, or operable to support a means for communicating via one or more beams generated in accordance with the adaptive beam weight generation procedure at the UE.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for generating adaptive beam weights for communications with multiple TRPs, which may allow for improved quality of communications.

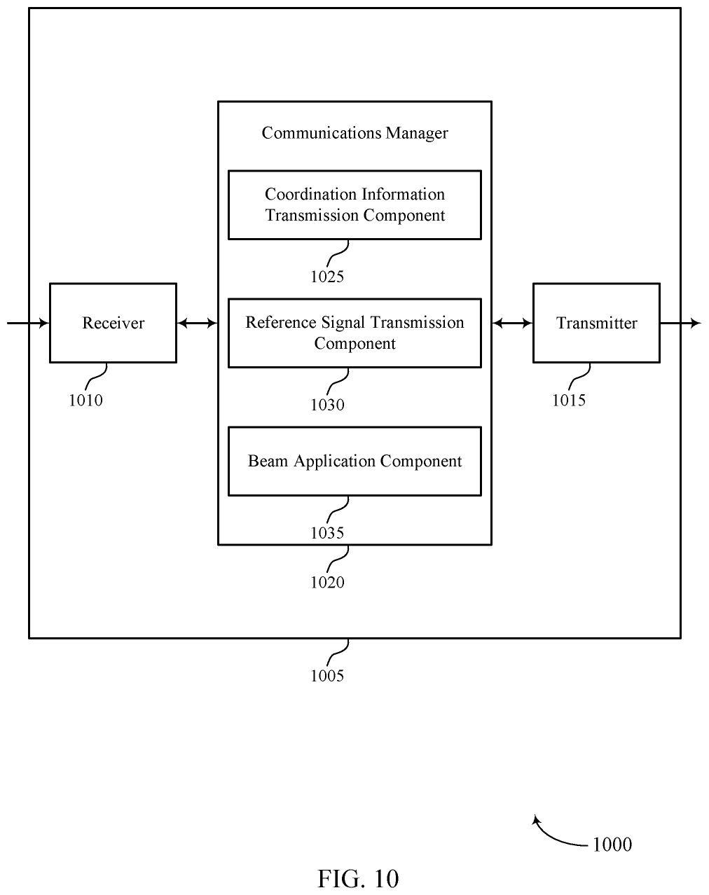

FIG. 10 shows a block diagram 1000 of a device 1005 that supports generating adaptive beam weights for communications with multiple TRPs in accordance with one or more aspects of the present disclosure. The device 1005 may be an example of aspects of a device 905 or an TRP as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of generating adaptive beam weights for communications with multiple TRPs as described herein. For example, the communications manager 1020 may include a coordination information transmission component 1025, a reference signal transmission component 1030, a beam application component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first TRP in accordance with examples as disclosed herein. The coordination information transmission component 1025 is capable of, configured to, or operable to support a means for transmitting signaling indicating coordination information associated with aligning one or more time-frequency resources for communications corresponding to a set of multiple TRPs, the set of multiple TRPs including the first TRP. The reference signal transmission component 1030 is capable of, configured to, or operable to support a means for transmitting, in accordance with the coordination information, one or more first reference signals associated with an adaptive beam weight generation procedure at a UE. The beam application component 1035 is capable of, configured to, or operable to support a means for communicating via one or more beams generated in accordance with the adaptive beam weight generation procedure at the UE.

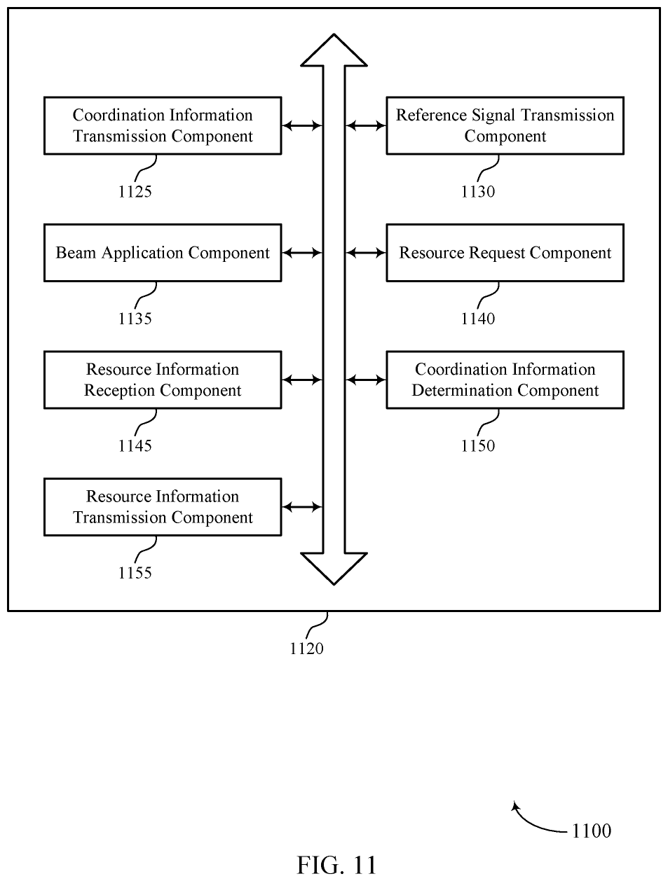

FIG. 11 shows a block diagram 1100 of a communications manager 1120 that supports generating adaptive beam weights for communications with multiple TRPs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of generating adaptive beam weights for communications with multiple TRPs as described herein. For example, the communications manager 1120 may include a coordination information transmission component 1125, a reference signal transmission component 1130, a beam application component 1135, a resource request component 1140, a resource information reception component 1145, a coordination information determination component 1150, a resource information transmission component 1155, or any combination thereof. Each of these components, or components or subcomponents thereof (e.g., one or more processors, one or more memories), may communicate, directly or indirectly, with one another (e.g., via one or more buses).

The communications manager 1120 may support wireless communications at a first TRP in accordance with examples as disclosed herein. The coordination information transmission component 1125 is capable of, configured to, or operable to support a means for transmitting signaling indicating coordination information associated with aligning one or more time-frequency resources for communications corresponding to a set of multiple TRPs, the set of multiple TRPs including the first TRP. The reference signal transmission component 1130 is capable of, configured to, or operable to support a means for transmitting, in accordance with the coordination information, one or more first reference signals associated with an adaptive beam weight generation procedure at a UE. The beam application component 1135 is capable of, configured to, or operable to support a means for communicating via one or more beams generated in accordance with the adaptive beam weight generation procedure at the UE.

In some examples, the resource request component 1140 is capable of, configured to, or operable to support a means for transmitting, to a second TRP of the set of multiple TRPs, a request for first time-frequency resource information associated with one or more second reference signals associated with the second TRP. In some examples, the resource information reception component 1145 is capable of, configured to, or operable to support a means for receiving, in response to the request, a message including the first time-frequency resource information. In some examples, the coordination information determination component 1150 is capable of, configured to, or operable to support a means for determining the coordination information based on the first time-frequency resource information and second time frequency resource information associated with the one or more first reference signals.

In some examples, the resource information transmission component 1155 is capable of, configured to, or operable to support a means for transmitting, to a second TRP of the set of multiple TRPs, a message including time-frequency resource information corresponding to the one or more first reference signals.

In some examples, the one or more first reference signals are transmitted using the one or more time-frequency resources, the one or more time-frequency resources corresponding to a set of multiple reference signals including the one or more first reference signals and one or more second reference signals associated with a second TRP of the set of multiple TRPs.

In some examples, the coordination information includes one or more TAEs associated with the first TRP, one or more CFOs associated with the first TRP, or any combination thereof.

In some examples, a numerical quantity of reference signals in the one or more first reference signals is based on a numerical quantity of antenna element arrays of the UE.

In some examples, the one or more first reference signals include channel state information reference signals, synchronization signal block reference signals, or both.

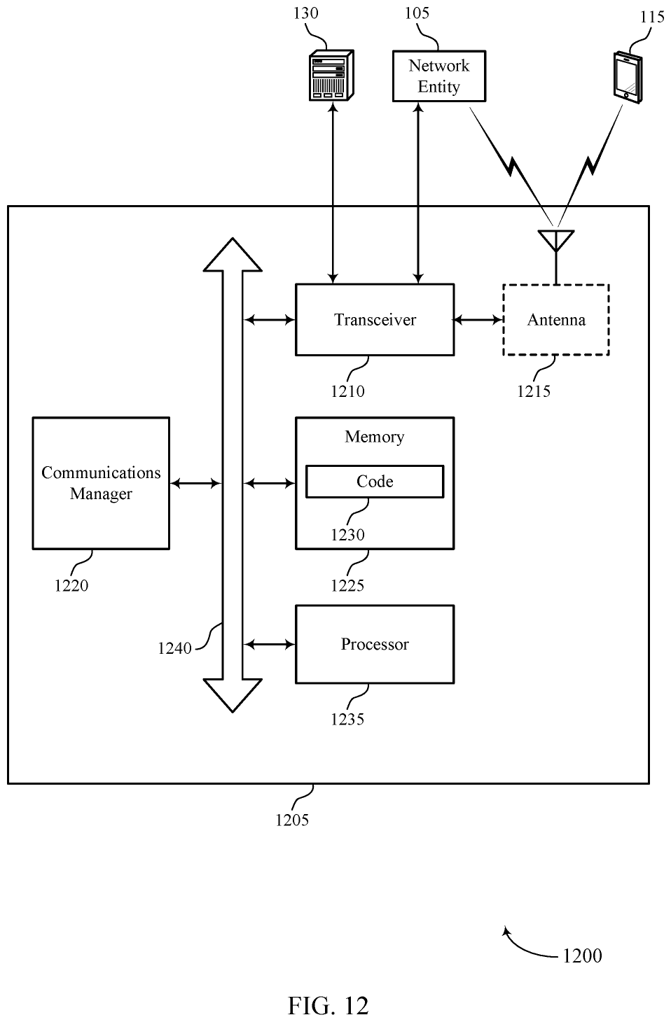

FIG. 12 shows a diagram of a system 1200 including a device 1205 that supports generating adaptive beam weights for communications with multiple TRPs in accordance with one or more aspects of the present disclosure. The device 1205 may be an example of or include the components of a device 905, a device 1005, or an TRP as described herein. The device 1205 may include components for bi-directional voice and data communications including components for transmitting and receiving communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting generating adaptive beam weights for communications with multiple TRPs). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a first TRP in accordance with examples as disclosed herein. For example, the communications manager 1220 is capable of, configured to, or operable to support a means for transmitting signaling indicating coordination information associated with aligning one or more time-frequency resources for communications corresponding to a set of multiple TRPs, the set of multiple TRPs including the first TRP. The communications manager 1220 is capable of, configured to, or operable to support a means for transmitting, in accordance with the coordination information, one or more first reference signals associated with an adaptive beam weight generation procedure at a UE. The communications manager 1220 is capable of, configured to, or operable to support a means for communicating via one or more beams generated in accordance with the adaptive beam weight generation procedure at the UE.

By including or configuring the communications manager 1220 in accordance with examples as described herein, the device 1205 may support techniques for generating adaptive beam weights for communications with multiple TRPs, which may allow for improved communication reliability, reduced latency, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of generating adaptive beam weights for communications with multiple TRPs as described herein, or the processor 1235 and the memory 1225 may be otherwise configured to perform or support such operations.

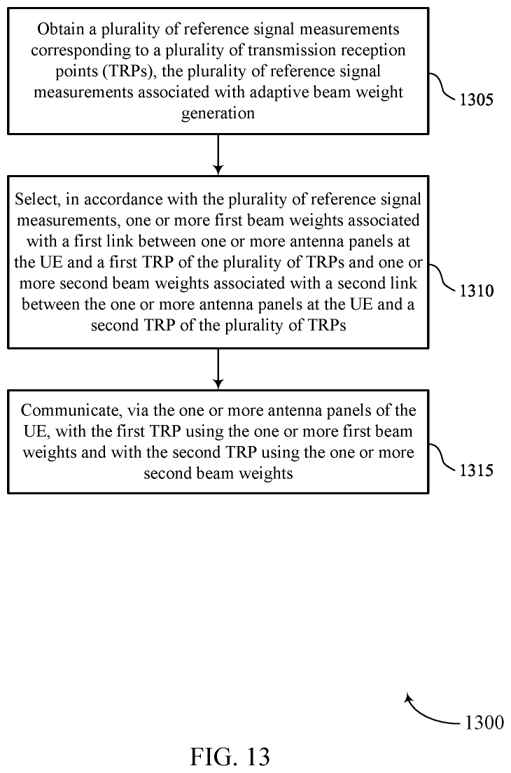

FIG. 13 shows a flowchart illustrating a method 1300 that supports generating adaptive beam weights for communications with multiple TRPs in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include obtaining a set of multiple reference signal measurements corresponding to a set of TRPs, the set of multiple reference signal measurements associated with adaptive beam weight generation. The operations of block 1305 may be performed in accordance with examples as disclosed herein. In some examples, aspects of the operations of 1305 may be performed by a reference signal measurement manager 725 as described with reference to FIG. 7.

At 1310, the method may include selecting, in accordance with the set of multiple reference signal measurements, one or more first beam weights associated with a first link between one or more antenna panels at the UE and a first TRP of the set of multiple TRPs and one or more second beam weights associated with a second link between the one or more antenna panels at the UE and a second TRP of the set of multiple TRPs. The operations of block 1310 may be performed in accordance with examples as disclosed herein. In some examples, aspects of the operations of 1310 may be performed by a beam weight selection manager 730 as described with reference to FIG. 7.

At 1315, the method may include communicating, via the one or more antenna panels of the UE, with the first TRP using the one or more first beam weights and with the second TRP using the one or more second beam weights. The operations of block 1315 may be performed in accordance with examples as disclosed herein. In some examples, aspects of the operations of 1315 may be performed by a beam weight application manager 735 as described with reference to FIG. 7.

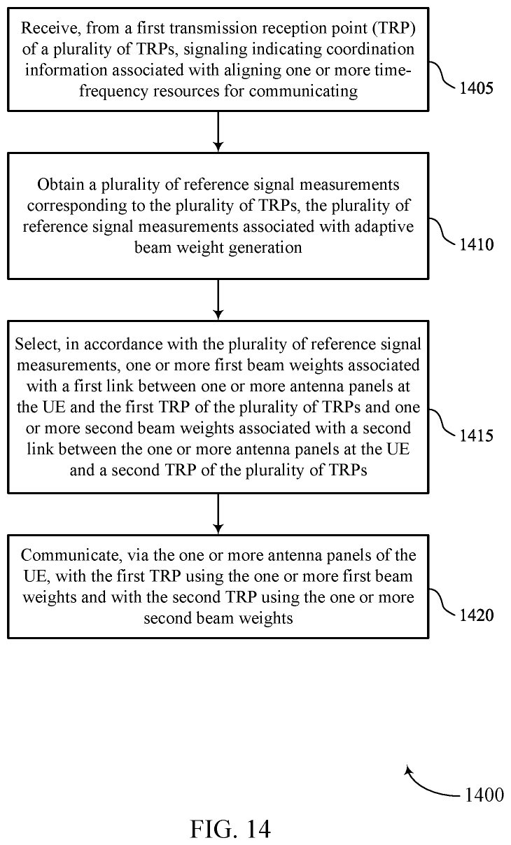

FIG. 14 shows a flowchart illustrating a method 1400 that supports generating adaptive beam weights for communications with multiple TRPs in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a first TRP of a set of multiple TRPs, signaling indicating coordination information associated with aligning one or more time-frequency resources for communicating. The operations of block 1405 may be performed in accordance with examples as disclosed herein. In some examples, aspects of the operations of 1405 may be performed by an TRP coordination manager 740 as described with reference to FIG. 7.

At 1410, the method may include obtaining a set of multiple reference signal measurements corresponding to the set of TRPs, the set of multiple reference signal measurements associated with adaptive beam weight generation. The operations of block 1410 may be performed in accordance with examples as disclosed herein. In some examples, aspects of the operations of 1410 may be performed by a reference signal measurement manager 725 as described with reference to FIG. 7.

At 1415, the method may include selecting, in accordance with the set of multiple reference signal measurements, one or more first beam weights associated with a first link between one or more antenna panels at the UE and the first TRP of the set of multiple TRPs and one or more second beam weights associated with a second link between the one or more antenna panels at the UE and a second TRP of the set of multiple TRPs. The operations of block 1415 may be performed in accordance with examples as disclosed herein. In some examples, aspects of the operations of 1415 may be performed by a beam weight selection manager 730 as described with reference to FIG. 7.

At 1420, the method may include communicating, via the one or more antenna panels of the UE, with the first TRP using the one or more first beam weights and with the second TRP using the one or more second beam weights. The operations of block 1420 may be performed in accordance with examples as disclosed herein. In some examples, aspects of the operations of 1420 may be performed by a beam weight application manager 735 as described with reference to FIG. 7.

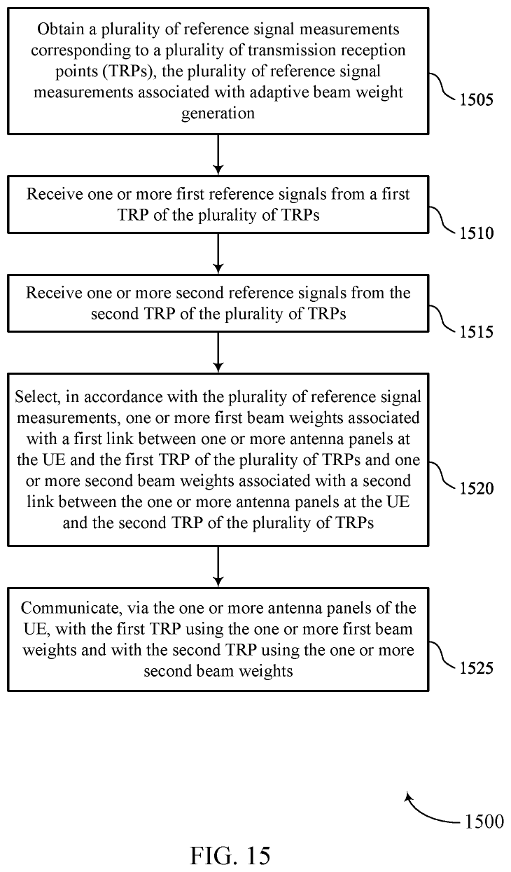

FIG. 15 shows a flowchart illustrating a method 1500 that supports generating adaptive beam weights for communications with multiple TRPs in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include obtaining a set of multiple reference signal measurements corresponding to a set of multiple TRPs, the set of multiple reference signal measurements associated with adaptive beam weight generation. The operations of block 1505 may be performed in accordance with examples as disclosed herein. In some examples, aspects of the operations of 1505 may be performed by a reference signal measurement manager 725 as described with reference to FIG. 7.

At 1510, the method may include receiving one or more first reference signals from a first TRP of the set of multiple TRPs. The operations of block 1510 may be performed in accordance with examples as disclosed herein. In some examples, aspects of the operations of 1510 may be performed by a reference signal reception manager 745 as described with reference to FIG. 7.

At 1515, the method may include receiving one or more second reference signals from a second TRP of the set of multiple TRPs. The operations of block 1515 may be performed in accordance with examples as disclosed herein. In some examples, aspects of the operations of 1515 may be performed by a reference signal reception manager 745 as described with reference to FIG. 7.

At 1520, the method may include selecting, in accordance with the set of multiple reference signal measurements, one or more first beam weights associated with a first link between one or more antenna panels at the UE and the first TRP of the set of multiple TRPs and one or more second beam weights associated with a second link between the one or more antenna panels at the UE and a second TRP of the set of multiple TRPs. The operations of block 1520 may be performed in accordance with examples as disclosed herein. In some examples, aspects of the operations of 1520 may be performed by a beam weight selection manager 730 as described with reference to FIG. 7.

At 1525, the method may include communicating, via the one or more antenna panels of the UE, with the first TRP using the one or more first beam weights and with the second TRP using the one or more second beam weights. The operations of block 1525 may be performed in accordance with examples as disclosed herein. In some examples, aspects of the operations of 1525 may be performed by a beam weight application manager 735 as described with reference to FIG. 7.

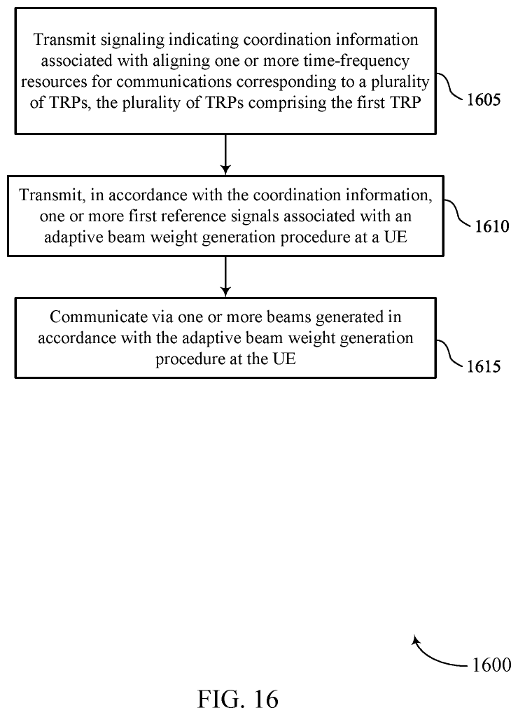

FIG. 16 shows a flowchart illustrating a method 1600 that supports generating adaptive beam weights for communications with multiple TRPs in accordance with aspects of the present disclosure. The operations of the method 1600 may be implemented by an TRP or its components as described herein. For example, the operations of the method 1600 may be performed by an TRP as described with reference to FIGS. 1 through 4 and 9 through 12. In some examples, an TRP may execute a set of instructions to control the functional elements of the TRP to perform the described functions. Additionally, or alternatively, the TRP may perform aspects of the described functions using special-purpose hardware.

At 1605, the method may include transmitting signaling indicating coordination information associated with aligning one or more time-frequency resources for communications corresponding to a set of multiple TRPs, the set of multiple TRPs including the first TRP. The operations of block 1605 may be performed in accordance with examples as disclosed herein. In some examples, aspects of the operations of 1605 may be performed by a coordination information transmission component 1125 as described with reference to FIG. 11.

At 1610, the method may include transmitting, in accordance with the coordination information, one or more first reference signals associated with an adaptive beam weight generation procedure at a UE. The operations of block 1610 may be performed in accordance with examples as disclosed herein. In some examples, aspects of the operations of 1610 may be performed by a reference signal transmission component 1130 as described with reference to FIG. 11.

At 1615, the method may include communicating via one or more beams generated in accordance with the adaptive beam weight generation procedure at the UE. The operations of block 1615 may be performed in accordance with examples as disclosed herein. In some examples, aspects of the operations of 1615 may be performed by a beam application component 1135 as described with reference to FIG. 11.

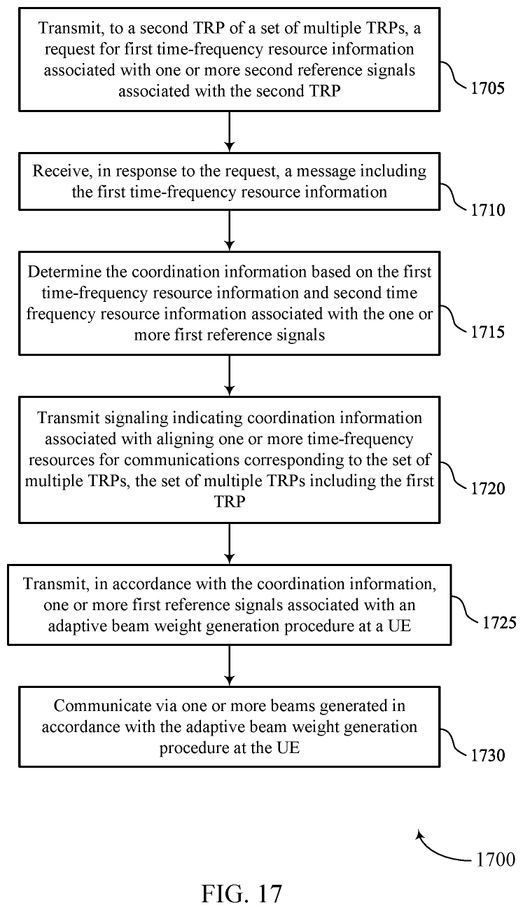

FIG. 17 shows a flowchart illustrating a method 1700 that supports generating adaptive beam weights for communications with multiple TRPs in accordance with aspects of the present disclosure. The operations of the method 1700 may be implemented by an TRP or its components as described herein. For example, the operations of the method 1700 may be performed by an TRP as described with reference to FIGS. 1 through 4 and 9 through 12. In some examples, an TRP may execute a set of instructions to control the functional elements of the TRP to perform the described functions. Additionally, or alternatively, the TRP may perform aspects of the described functions using special-purpose hardware.

At 1705, the method may include transmitting, to a second TRP of a set of multiple TRPs, a request for first time-frequency resource information associated with one or more second reference signals associated with the second TRP. The operations of block 1705 may be performed in accordance with examples as disclosed herein. In some examples, aspects of the operations of 1705 may be performed by a resource request component 1140 as described with reference to FIG. 11.

At 1710, the method may include receiving, in response to the request, a message including the first time-frequency resource information. The operations of block 1710 may be performed in accordance with examples as disclosed herein. In some examples, aspects of the operations of 1710 may be performed by a resource information reception component 1145 as described with reference to FIG. 11.

At 1715, the method may include determining the coordination information based on the first time-frequency resource information and second time frequency resource information associated with the one or more first reference signals. The operations of block 1715 may be performed in accordance with examples as disclosed herein. In some examples, aspects of the operations of 1715 may be performed by a coordination information determination component 1150 as described with reference to FIG. 11.

At 1720, the method may include transmitting signaling indicating coordination information associated with aligning one or more time-frequency resources for communications corresponding to the set of multiple TRPs, the set of multiple TRPs including the first TRP. The operations of block 1720 may be performed in accordance with examples as disclosed herein. In some examples, aspects of the operations of 1720 may be performed by a coordination information transmission component 1125 as described with reference to FIG. 11.

At 1725, the method may include transmitting, in accordance with the coordination information, one or more first reference signals associated with an adaptive beam weight generation procedure at a UE. The operations of block 1725 may be performed in accordance with examples as disclosed herein. In some examples, aspects of the operations of 1725 may be performed by a reference signal transmission component 1130 as described with reference to FIG. 11.

At 1730, the method may include communicating via one or more beams generated in accordance with the adaptive beam weight generation procedure at the UE. The operations of block 1730 may be performed in accordance with examples as disclosed herein. In some examples, aspects of the operations of 1730 may be performed by a beam application component 1135 as described with reference to FIG. 11.

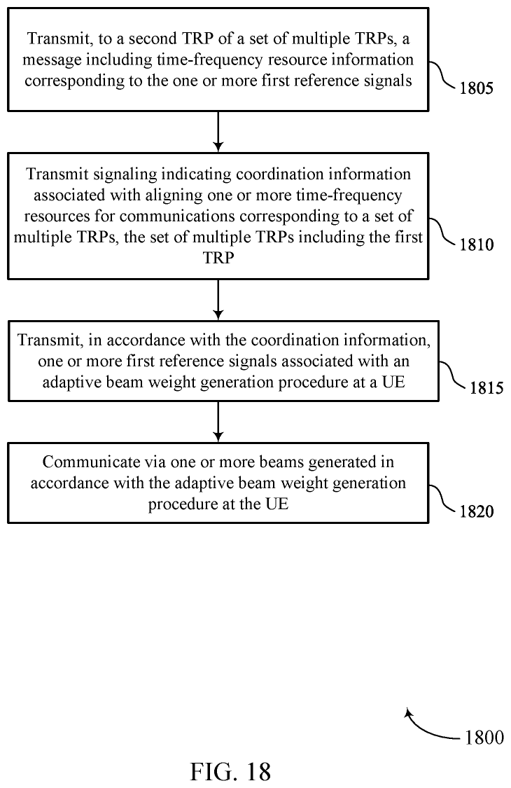

FIG. 18 shows a flowchart illustrating a method 1800 that supports generating adaptive beam weights for communications with multiple TRPs in accordance with aspects of the present disclosure. The operations of the method 1800 may be implemented by an TRP or its components as described herein. For example, the operations of the method 1800 may be performed by an TRP as described with reference to FIGS. 1 through 4 and 9 through 12. In some examples, an TRP may execute a set of instructions to control the functional elements of the TRP to perform the described functions. Additionally, or alternatively, the TRP may perform aspects of the described functions using special-purpose hardware.

At 1805, the method may include transmitting, to a second TRP of a set of multiple TRPs, a message including time-frequency resource information corresponding to the one or more first reference signals. The operations of block 1805 may be performed in accordance with examples as disclosed herein. In some examples, aspects of the operations of 1805 may be performed by a resource information transmission component 1155 as described with reference to FIG. 11.

At 1810, the method may include transmitting signaling indicating coordination information associated with aligning one or more time-frequency resources for communications corresponding to a set of multiple TRPs, the set of multiple TRPs including the first TRP. The operations of block 1810 may be performed in accordance with examples as disclosed herein. In some examples, aspects of the operations of 1810 may be performed by a coordination information transmission component 1125 as described with reference to FIG. 11.

At 1815, the method may include transmitting, in accordance with the coordination information, one or more first reference signals associated with an adaptive beam weight generation procedure at a UE. The operations of block 1815 may be performed in accordance with examples as disclosed herein. In some examples, aspects of the operations of 1815 may be performed by a reference signal transmission component 1130 as described with reference to FIG. 11.

At 1820, the method may include communicating via one or more beams generated in accordance with the adaptive beam weight generation procedure at the UE. The operations of block 1820 may be performed in accordance with examples as disclosed herein. In some examples, aspects of the operations of 1820 may be performed by a beam application component 1135 as described with reference to FIG. 11.

The following provides an overview of aspects of the present disclosure:

Aspect 1: A method for wireless communications at a UE, comprising: obtaining a plurality of reference signal measurements corresponding to a plurality of TRPs, the plurality of reference signal measurements associated with adaptive beam weight generation; selecting, in accordance with the plurality of reference signal measurements, one or more first beam weights associated with a first link between one or more antenna panels at the UE and a first TRP of the plurality of TRPs and one or more second beam weights associated with a second link between the one or more antenna panels at the UE and a second TRP of the plurality of TRPs; and communicating, via the one or more antenna panels of the UE, with the first TRP using the one or more first beam weights and with the second TRP using the one or more second beam weights.

Aspect 2: The method of aspect 1, further comprising: receiving, from the first TRP of the plurality of TRPs, signaling indicating coordination information associated with aligning one or more time-frequency resources for the communicating.

Aspect 3: The method of aspect 2, wherein the coordination information comprises one or more TAEs associated with the first TRP and the second TRP, one or more CFOs associated with the first TRP and the second TRP, or any combination thereof.

Aspect 4: The method of any of aspects 1 through 3, wherein obtaining the plurality of reference signal measurements comprises: receiving one or more first reference signals from the first TRP; and receiving one or more second reference signals from the second TRP.

Aspect 5: The method of claim 4, wherein the one or more first reference signals correspond to a first set of time-frequency resources; and the one or more second reference signals correspond to a second set of time-frequency resources.

Aspect 6: The method of any of aspects 1 through 5, further comprising: refraining from storing the one or more first beam weights and the one or more second beam weights in RFIC memory.

Aspect 7: The method of any of aspects 1 through 6, wherein a numerical quantity of a plurality of reference signals corresponding to the plurality of reference signal measurements is based at least in part on a numerical quantity of antenna element arrays of the UE.

Aspect 8: The method of any of aspects 1 through 7, wherein the selecting the one or more first beam weights associated with the first link between the one or more antenna panels at the UE and the first TRP and the one or more second beam weights associated with the second link between the one or more antenna panels at the UE and the second TRP comprises: calculating a plurality of beam weights based at least in part on co-phasing first energy associated with at least one first reference signal measurement corresponding to the first TRP with second energy associated with at least one second reference signal measurement corresponding to the second TRP, the plurality of reference signal measurements comprising the at least one first reference signal measurement and the at least one second reference signal measurement; quantizing the plurality of calculated beam weights based at least in part on a beam weight codebook; and projecting the plurality of quantized beam weights onto the beam weight codebook, wherein the plurality of quantized beam weights comprises the one or more first beam weights and the one or more second beam weights.

Aspect 9: The method of claim 1, wherein the plurality of reference signal measurements comprise CSI-RS measurements, SSB reference signal measurements, or both.

Aspect 10: A method for wireless communications at a first TRP, comprising: transmitting signaling indicating coordination information associated with aligning one or more time-frequency resources for communications corresponding to a plurality of TRPs, the plurality of TRPs comprising the first TRP; transmitting, in accordance with the coordination information, one or more first reference signals associated with an adaptive beam weight generation procedure at a UE; and communicating via one or more beams generated in accordance with the adaptive beam weight generation procedure at the UE.

Aspect 11: The method of aspect 10, further comprising: transmitting, to a second TRP of the plurality of TRPs, a request for first time-frequency resource information associated with one or more second reference signals associated with the second TRP; receiving, in response to the request, a message comprising the first time-frequency resource information; and determining the coordination information based at least in part on the first time-frequency resource information and second time frequency resource information associated with the one or more first reference signals.

Aspect 12: The method of any of aspects 10 through 11, further comprising: transmitting, to a second TRP of the plurality of TRPs, a message comprising time-frequency resource information corresponding to the one or more first reference signals.

Aspect 13: The method of any of aspects 10 through 12, wherein the one or more first reference signals are transmitted using the one or more time-frequency resources, the one or more time-frequency resources corresponding to a plurality of reference signals comprising the one or more first reference signals and one or more second reference signals associated with a second TRP of the plurality of TRPs.

Aspect 14: The method of any of aspects 10 through 13, wherein the coordination information comprises one or more TAEs associated with the first TRP, one or more CFOs associated with the first TRP, or any combination thereof.

Aspect 15: The method of any of aspects 10 through 14, wherein a numerical quantity of reference signals in the one or more first reference signals is based at least in part on a numerical quantity of antenna element arrays of the UE.

Aspect 16: The method of any of aspects 10 through 15, wherein the one or more first reference signals comprise CSI-RSs, SSB reference signals, or both.

Aspect 17: An apparatus for wireless communications at a UE, comprising at least one processor; at least one memory coupled with the at least one processor; and instructions stored in the at least one memory and executable by the at least one processor to cause the apparatus to perform a method of any of aspects 1 through 9.

Aspect 18: An apparatus for wireless communications at a UE, comprising at least one means for performing a method of any of aspects 1 through 9.

Aspect 19: A non-transitory computer-readable medium storing code for wireless communications at a UE, the code comprising instructions executable by at least one processor to perform a method of any of aspects 1 through 9.

Aspect 20: An apparatus for wireless communications at a first TRP, comprising at least one processor; at least one memory coupled with the at least one processor; and instructions stored in the at least one memory and executable by the at least one processor to cause the apparatus to perform a method of any of aspects 10 through 16.

Aspect 21: An apparatus for wireless communications at a first TRP, comprising at least one means for performing a method of any of aspects 10 through 16.

Aspect 22: A non-transitory computer-readable medium storing code for wireless communications at a first TRP, the code comprising instructions executable by at least one processor to perform a method of any of aspects 10 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor;
at least one memory coupled with the at least one processor; and
instructions stored in the at least one memory and executable by the at least one processor to cause the apparatus to:
obtain a plurality of reference signal measurements corresponding to a plurality of transmission reception points (TRPs), the plurality of reference signal measurements associated with adaptive beam weight generation;
select, in accordance with the plurality of reference signal measurements, one or more first beam weights associated with a first link between one or more antenna panels at the UE and a first TRP of the plurality of TRPs and one or more second beam weights associated with a second link between the one or more antenna panels at the UE and a second TRP of the plurality of TRPs; and
communicate, via the one or more antenna panels of the UE, with the first TRP using the one or more first beam weights and with the second TRP using the one or more second beam weights.

2. The apparatus of claim 1, wherein the instructions are further executable by the at least one processor to cause the apparatus to:
receive, from the first TRP of the plurality of TRPs, signaling indicating coordination information associated with aligning one or more time-frequency resources for the communicating.

3. The apparatus of claim 2, wherein the coordination information comprises one or more timing alignment errors (TAEs) associated with the first TRP and the second TRP, one or more carrier frequency offsets (CFOs) associated with the first TRP and the second TRP, or any combination thereof.

4. The apparatus of claim 1, wherein the instructions to obtain the plurality of reference signal measurements are executable by the at least one processor to cause the apparatus to:
receive one or more first reference signals from the first TRP; and
receive one or more second reference signals from the second TRP.

5. The apparatus of claim 4, wherein:
the one or more first reference signals correspond to a first set of time-frequency resources; and
the one or more second reference signals correspond to a second set of time-frequency resources.

6. The apparatus of claim 1, wherein the instructions are further executable by the at least one processor to cause the apparatus to:
refrain from storing the one or more first beam weights and the one or more second beam weights in radio frequency integrated circuit (RFIC) memory.

7. The apparatus of claim 1, wherein a numerical quantity of a plurality of reference signals corresponding to the plurality of reference signal measurements is based at least in part on a numerical quantity of antenna element arrays of the UE.

8. The apparatus of claim 1, wherein the instructions to select the one or more first beam weights associated with the first link between the one or more antenna panels at the UE and the first TRP and the one or more second beam weights associated with the second link between the one or more antenna panels at the UE and the second TRP are executable by the at least one processor to cause the apparatus to:
calculate a plurality of beam weights based at least in part on co-phasing first energy associated with at least one first reference signal measurement corresponding to the first TRP with second energy associated with at least one second reference signal measurement corresponding to the second TRP, the plurality of reference signal measurements comprising the at least one first reference signal measurement and the at least one second reference signal measurement;
quantize the plurality of calculated beam weights based at least in part on a beam weight codebook; and
project the plurality of quantized beam weights onto the beam weight codebook, wherein the plurality of quantized beam weights comprises the one or more first beam weights and the one or more second beam weights.

9. The apparatus of claim 1, wherein the plurality of reference signal measurements comprise channel state information reference signal (CSI-RS) measurements, synchronization signal block (SSB) reference signal measurements, or both.

10. An apparatus for wireless communications at a first transmission reception point (TRP), comprising:
at least one processor;
at least one memory coupled with the at least one processor; and
instructions stored in the at least one memory and executable by the at least one processor to cause the apparatus to:
transmit signaling indicating coordination information associated with aligning one or more time-frequency resources for communications corresponding to a plurality of TRPs, the plurality of TRPs comprising the first TRP;
transmit, in accordance with the coordination information, one or more first reference signals associated with an adaptive beam weight generation procedure at a user equipment (UE); and
communicate via one or more beams generated in accordance with the adaptive beam weight generation procedure at the UE.

11. The apparatus of claim 10, wherein the instructions are further executable by the at least one processor to cause the apparatus to:
transmit, to a second TRP of the plurality of TRPs, a request for first time-frequency resource information associated with one or more second reference signals associated with the second TRP;
receive, in response to the request, a message comprising the first time-frequency resource information; and
determine the coordination information based at least in part on the first time-frequency resource information and second time frequency resource information associated with the one or more first reference signals.

12. The apparatus of claim 10, wherein the instructions are further executable by the at least one processor to cause the apparatus to:
transmit, to a second TRP of the plurality of TRPs, a message comprising time-frequency resource information corresponding to the one or more first reference signals.

13. The apparatus of claim 10, wherein the one or more first reference signals are transmitted using the one or more time-frequency resources, the one or more time-frequency resources corresponding to a plurality of reference signals comprising the one or more first reference signals and one or more second reference signals associated with a second TRP of the plurality of TRPs.

14. The apparatus of claim 10, wherein the coordination information comprises one or more timing alignment errors associated with the first TRP, one or more carrier frequency offsets associated with the first TRP, or any combination thereof.

15. The apparatus of claim 10, wherein a numerical quantity of reference signals in the one or more first reference signals is based at least in part on a numerical quantity of antenna element arrays of the UE.

16. The apparatus of claim 10, wherein the one or more first reference signals comprise channel state information reference signals, synchronization signal block reference signals, or both.

17. A method for wireless communications at a user equipment (UE), comprising:
obtaining a plurality of reference signal measurements corresponding to a plurality of transmission reception points (TRPs), the plurality of reference signal measurements associated with adaptive beam weight generation;
selecting, in accordance with the plurality of reference signal measurements, one or more first beam weights associated with a first link between one or more antenna panels at the UE and a first TRP of the plurality of TRPs and one or more second beam weights associated with a second link between the one or more antenna panels at the UE and a second TRP of the plurality of TRPs; and
communicating, via the one or more antenna panels of the UE, with the first TRP using the one or more first beam weights and with the second TRP using the one or more second beam weights.

18. The method of claim 17, further comprising:
receiving, from the first TRP of the plurality of TRPs, signaling indicating coordination information associated with aligning one or more time-frequency resources for the communicating.

19. The method of claim 18, wherein the coordination information comprises one or more timing alignment errors (TAEs) associated with the first TRP and the second TRP, one or more carrier frequency offsets (CFOs) associated with the first TRP and the second TRP, or any combination thereof.

20. The method of claim 17, wherein obtaining the plurality of reference signal measurements comprises:
receiving one or more first reference signals from the first TRP; and
receiving one or more second reference signals from the second TRP.

21. The method of claim 20, wherein:
the one or more first reference signals correspond to a first set of time-frequency resources; and
the one or more second reference signals correspond to a second set of time-frequency resources.

22. The method of claim 17, further comprising:
refraining from storing the one or more first beam weights and the one or more second beam weights in radio frequency integrated circuit (RFIC) memory.

23. The method of claim 17, wherein a numerical quantity of a plurality of reference signals corresponding to the plurality of reference signal measurements is based at least in part on a numerical quantity of antenna element arrays of the UE.

24. The method of claim 17, wherein the selecting the one or more first beam weights associated with the first link between the one or more antenna panels at the UE and the first TRP and the one or more second beam weights associated with the second link between the one or more antenna panels at the UE and the second TRP comprises:
calculating a plurality of beam weights based at least in part on co-phasing first energy associated with at least one first reference signal measurement corresponding to the first TRP with second energy associated with at least one second reference signal measurement corresponding to the second TRP, the plurality of reference signal measurements comprising the at least one first reference signal measurement and the at least one second reference signal measurement;
quantizing the plurality of calculated beam weights based at least in part on a beam weight codebook; and
projecting the plurality of quantized beam weights onto the beam weight codebook, wherein the plurality of quantized beam weights comprises the one or more first beam weights and the one or more second beam weights.

25. The method of claim 17, wherein the plurality of reference signal measurements comprise channel state information reference signal (CSI-RS) measurements, synchronization signal block (SSB) reference signal measurements, or both.

26. A method for wireless communications at a first transmission reception point (TRP), comprising:
transmitting signaling indicating coordination information associated with aligning one or more time-frequency resources for communications corresponding to a plurality of TRPs, the plurality of TRPs comprising the first TRP;
transmitting, in accordance with the coordination information, one or more first reference signals associated with an adaptive beam weight generation procedure at a user equipment (UE); and
communicating via one or more beams generated in accordance with the adaptive beam weight generation procedure at the UE.

27. The method of claim 26, further comprising:
transmitting, to a second TRP of the plurality of TRPs, a request for first time-frequency resource information associated with one or more second reference signals associated with the second TRP;
receiving, in response to the request, a message comprising the first time-frequency resource information; and
determining the coordination information based at least in part on the first time-frequency resource information and second time frequency resource information associated with the one or more first reference signals.

28. The method of claim 26, further comprising:
transmitting, to a second TRP of the plurality of TRPs, a message comprising time-frequency resource information corresponding to the one or more first reference signals.

29. The method of claim 26, wherein the one or more first reference signals are transmitted using the one or more time-frequency resources, the one or more time-frequency resources corresponding to a plurality of reference signals comprising the one or more first reference signals and one or more second reference signals associated with a second TRP of the plurality of TRPs.

30. The method of claim 26, wherein the coordination information comprises one or more timing alignment errors associated with the first TRP, one or more carrier frequency offsets associated with the first TRP, or any combination thereof.
